(19) United States
(12) Patent Application Publication
(10) Pub. No.: US 2017/0190317 A1
(43) Pub. Date: Jul. 6, 2017

(54) VEHICLE-USE COMMUNICATION SYSTEM, IN-VEHICLE DEVICE, PORTABLE DEVICE, AND A NON-TRANSITORY COMPUTER-READABLE RECORDING MEDIUM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Yoshihiro Hamada, Osaka-shi, Osaka (JP); Qiying Li, Yokkaichi-shi, Mie (JP); Hiroyuki Kurata, Yokkaichi-shi, Mie (JP)

(21) Appl. No.: 15/325,841

(22) PCT Filed: Jun. 24, 2015
(86) PCT No.: PCT/JP2015/068146

§ 371 Date: Jan. 12, 2017

(30) Foreign Application Priority Data
Jul. 14, 2014 (JP) 2014-144432

(51) Int. Cl. B60R 25/24; B60R 25/01; H04B 17/318; B60R 25/20

(52) U.S. Cl. CPC B60R 25/241; B60R 25/209; B60R 25/245; B60R 25/01; H04B 17/318

(57) ABSTRACT

A vehicle-use communication system configured to detect the position of a portable device. The system includes an in-vehicle device transmitting a signal from a plurality of antennas in the vehicle when any one of a plurality of operation parts on an outer face of a vehicle is operated. A portable device receives the transmitted signal and measures the signal strength of the received signal, and transmits a response signal containing the signal strength. The in-vehicle device stores information concerning each of a plurality of areas of the vehicle cabin. The in-vehicle device identifies the operated operation part and selects information concerning one area, in which the operation part has been identified, from the information concerning the plurality of areas. On the basis of the received signal strengths and the information concerning the selected one area, the in-vehicle device determines whether the portable device is located within the area.

### CROSS-REFERENCE TO RELATED APPLICATIONS

This application is the national phase under 35 U.S.C. §371 of PCT International Application No. PCT/JP2015/068146 which has an International filing date of Jun. 24, 2015 and designated the United States of America, and claims priority to Japanese Application No. 2014-144432 filed on Jul. 14, 2014.

### FIELD

The present patent disclosure relates to: a vehicle-use communication system; an in-vehicle device and a portable device constituting the vehicle-use communication system; and a computer program.

### BACKGROUND

A vehicle-use communication system is in practical use in which locking or unlocking of a vehicle door is achieved without the use of a mechanical key. Specifically, such systems in practical use include: a keyless entry system in which locking or unlocking of a vehicle door is achieved by wireless remote operation by using a portable device carried by a user; and a smart entry (registered trademark) system in which a vehicle door is unlocked when a user carrying a portable device merely approaches the vehicle or merely grips the door handle.

Further, a vehicle-use communication system is also in practical use in which engine start in a vehicle is achieved without the use of a mechanical key. Specifically, a smart start system is in practical use in which the engine is started when a user carrying a portable device merely pushes an engine start button.

In the communication systems described above, the in-vehicle device performs communication with the portable device by using radio signals so as to perform authentication and, after that, perform control concerning the given operation of unlocking, locking, engine start, or the like. However, for the purpose of preventing unauthorized operation, before the operation is executed, it is checked whether the portable device is located at a given position.

An in-vehicle device according to Japanese Patent Application Laid-Open Publication No. 2002-081248 includes a storage part. Then, when an authorized portable device is authenticated in the vehicle cabin, the history of authentication is stored in the storage part. The history of authentication is kept stored in the storage part for a given time such as several seconds. During the time that the history of authentication is kept stored in the storage part, without requesting new authentication, the in-vehicle device performs control of given operation of unlocking, locking, engine start, or the like. Thus, when the portable device has been authenticated by the in-vehicle device, the user is allowed to cause the in-vehicle device to perform the given operation without the necessity of new authentication. Thus, in the in-vehicle device described in Japanese Patent Application Laid-Open Publication No. 2002-081248, the time elapsing until the given operation is actually executed is allowed to be reduced.

An in-vehicle device according to Japanese Patent Application Laid-Open Publication No. 2007-205004 is a disclosure of a keyless entry apparatus in which a portable device receives signals transmitted from a plurality of antennas provided in a vehicle and the position of the portable device is determined on the basis of the received signal strengths of the signals received by the portable device. The in-vehicle device according to Japanese Patent Application Laid-Open Publication No. 2007-205004 stores, in advance, data required for determination of the position of the portable device. The data includes: prior-to-operation data of a movable member provided in the vehicle; and data posterior to the operation. The in-vehicle device detects the state of operation of the movable member and utilizes the data prior to the operation or the data posterior to the operation in accordance with the detected state.

Thus, the in-vehicle device is allowed to change the data used in the determination of the position of the portable device, in accordance with the state of the movable member. This enhances the accuracy of the determination.

However, in the in-vehicle device according to Japanese Patent Application Laid-Open Publication No. 2002-081248, the given operation is performed without the necessity of new authentication for a given time. This causes a possibility that any operation is performed by a person other than the user carrying the portable device so that operation not intended by the user is executed and hence convenience is damaged.

Further, in the in-vehicle device according to Japanese Patent Application Laid-Open Publication No. 2007-205004, the data used in the determination of the position of the portable device is not allowed to be changed in accordance with the positional relation between the portable device and the vehicle. Thus, a possibility of insufficient determination accuracy is caused depending on the positional relation between the user and the vehicle.

An object of the present patent application is to provide: a vehicle-use communication system in the position determination of a portable device performed such that the portable device receives signals transmitted from a plurality of antennas provided on a vehicle side and then the position determination is achieved on the basis of the received signal strengths of the signals measured by the portable device, the time required for the determination is reduced and satisfactory determination accuracy is achieved; an in-vehicle device and a portable device constituting the vehicle-use communication system; and a computer program.

### SUMMARY

The vehicle-use communication system according to an aspect of the present disclosure is a vehicle-use communication system comprising: an in-vehicle device, when any one of a plurality of operation parts provided in an outer face of a vehicle is operated, transmitting a signal from a plurality of antennas provided on the vehicle; and a portable device receiving the signal transmitted from the in-vehicle device, measuring a received signal strength of the received signal, and transmitting a response signal containing the measured received signal strength of the signal, wherein the in-vehicle device includes: a storage part storing information concerning each of a plurality of areas different from each other but containing a common vehicle cabin inner space; an identification part identifying an operation part having been operated among the plurality of operation parts; a selection part, in accordance with which operation part has been identified by the identification part, selecting information concerning one area from the information individually concerning the plurality of areas stored in the storage part; an in-vehicle receiving part receiving the response signal transmitted from the portable device; and a determination part, on the basis of the received signal strengths contained in the response signals received by the in-vehicle receiving part and on the basis of the information concerning the one area selected by the selection part, determining whether the portable device is located within the area.

The in-vehicle device according to an aspect of the present disclosure is an in-vehicle device, when any one of a plurality of operation parts provided in an outer face of a vehicle is operated, transmitting a signal from a plurality of antennas arranged in the vehicle and receiving a response signal transmitted from an external equipment in accordance with the signal, comprising: a storage part storing information concerning each of a plurality of areas different from each other but containing a common vehicle cabin inner space; an identification part identifying an operation part having been operated among the plurality of operation parts; a selection part, in accordance with which operation part has been identified by the identification part, selecting information concerning one area from the information individually concerning the plurality of areas stored in the storage part; an in-vehicle receiving part receiving the response signals containing received signal strengths of the signals individually transmitted from the plurality of antennas measured at the external equipment; and a determination part, on the basis of the received signal strengths contained in the response signals received by the in-vehicle receiving part and on the basis of the information concerning the one area selected by the selection part, determining whether the external equipment is located within the area.

The portable device according to an aspect of the present disclosure is a portable device receiving a plurality of signals transmitted from a vehicle provided with a plurality of operation parts formed in an outer face when any one of the plurality of operation parts is operated, and transmitting response signals in accordance with the received signals, comprising: a storage part storing information concerning each of a plurality of areas different from each other but containing a common vehicle cabin inner space; an identification part, on the basis of the received signals, identifying an operation part having been operated among the plurality of operation parts; a selection part, in accordance with which operation part has been identified by the identification part, selecting information concerning one area from the information individually concerning the plurality of areas stored in the storage part; a measurement part measuring received signal strengths of the plurality of signals; and a determination part, on the basis of the received signal strengths measured by the measurement part and on the basis of the information concerning the one area selected by the selection part, determining whether itself is located within the area.

The computer program according to an aspect of the present disclosure is a computer program causing a computer to, on the basis of received signal strengths of signals which have been transmitted from a plurality of antennas arranged on a vehicle at a time that any one of a plurality of operation parts provided in an outer face of the vehicle is operated and which have been received by a portable device, determine whether the portable device is located within the vehicle cabin, wherein the computer is caused to serve as: an identification part identifying an operation part having been operated among the plurality of operation parts; a selection part, in accordance with which operation part has been identified, selecting one area from a plurality of areas different from each other but containing a common vehicle cabin inner space; and a determination part, on the basis of the received signal strengths, determining whether the portable device is located within the selected one area.

Here, in addition to a configuration that the present patent application is implemented as a vehicle-use communication system, an in-vehicle device, and a portable device employing such a characteristic processing part, the present patent application may be implemented as a vehicle communication method employing steps of such characteristic processing or, alternatively, as a program causing a computer to execute these steps. Further, the present patent application may be implemented as an integrated circuit used for realizing a part or all of the vehicle-use communication system, the in-vehicle device, and the portable device or, alternatively, as any other system including the vehicle-use communication system, the in-vehicle device, and the portable device.

The aspects given above are allowed to provide: a vehicle-use communication system in the position determination of a portable device performed such that the portable device receives signals transmitted from a plurality of antennas provided on a vehicle side and the position determination is achieved on the basis of the received signal strengths of the signals measured by the portable device, the time required for the determination is reduced and satisfactory determination accuracy is achieved; an in-vehicle device and a portable device constituting the vehicle-use communication system; and a computer program.

The above and further objects and features will more fully be apparent from the following detailed description with accompanying drawings.

### BRIEF DESCRIPTION OF THE DRAWINGS

FIG. 1 is a block diagram illustrating an exemplary configuration of a vehicle-use communication system according to Embodiment 1.

FIG. 2 is a block diagram illustrating an exemplary configuration of an in-vehicle device.

FIG. 3 is a block diagram illustrating an exemplary configuration of a portable device.

FIG. 4A is a conceptual diagram illustrating a first area.

FIG. 4B is a conceptual diagram illustrating a first area.

FIG. 5A is a conceptual diagram illustrating sampling locations concerning a first area.

FIG. 5B is a conceptual diagram illustrating sampling locations concerning a first area.

FIG. 6A is a conceptual diagram illustrating a second area.

FIG. 6B is a conceptual diagram illustrating a second area.

FIG. 7A is a conceptual diagram illustrating sampling locations concerning a second area.

FIG. 7B is a conceptual diagram illustrating a sampling location concerning a second area.

FIG. 8A is a conceptual diagram illustrating a third area.

FIG. 8B is a conceptual diagram illustrating a third area.

FIG. 9 is a flow chart illustrating a processing procedure at the time that a vehicle-use communication system performs vehicle cabin inside-or-outside determination of a portable device.

FIG. 10 is a flow chart illustrating a subroutine of prior-to-authentication communication processing.

FIG. 11 is a flow chart illustrating a subroutine of vehicle cabin inside-or-outside determination processing.

FIG. 12 is a flow chart illustrating the processing of a vehicle cabin inside-or-outside determination subroutine in Embodiment 2.

FIG. 13 is a flow chart illustrating the processing of a vehicle cabin inside-or-outside determination subroutine in Embodiment 3.

FIG. 14A is a sequence diagram illustrating various signals transmitted and received between an in-vehicle device and a portable device.

FIG. 14B is a sequence diagram illustrating various signals transmitted and received between an in-vehicle device and a portable device.

### DETAILED DESCRIPTION

### Description of the Embodiments of the Present Invention

First, aspects of the present disclosure are listed and described below. Further, at least a part of the aspects described below may arbitrarily be combined with each other.

(1) The vehicle-use communication system according to an aspect of the present disclosure is a vehicle-use communication system comprising: an in-vehicle device, when any one of a plurality of operation parts provided in an outer face of a vehicle is operated, transmitting a signal from a plurality of antennas provided on the vehicle; and a portable device receiving the signal transmitted from the in-vehicle device, measuring a received signal strength of the received signal, and transmitting a response signal containing the measured received signal strength of the signal, wherein the in-vehicle device includes: a storage part storing information concerning each of a plurality of areas different from each other but containing a common vehicle cabin inner space; an identification part identifying an operation part having been operated among the plurality of operation parts; a selection part, in accordance with which operation part has been identified by the identification part, selecting information concerning one area from the information individually concerning the plurality of areas stored in the storage part; an in-vehicle receiving part receiving the response signal transmitted from the portable device; and a determination part, on the basis of the received signal strengths contained in the response signals received by the in-vehicle receiving part and on the basis of the information concerning the one area selected by the selection part, determining whether the portable device is located within the area.

In the present patent disclosure, when any one of the plurality of operation parts provided in the outer face of the vehicle is operated, the in-vehicle device transmits a signal from the plurality of antennas provided on the vehicle. The signal is a signal used for determining the position of the portable device. The portable device receives the signal transmitted from each antenna, measures the received signal strength of each signal, and transmits to the in-vehicle device a response signal containing the received signal strength obtained by the measurement. The received signal strength of each signal varies depending on the position of the portable device relative to the vehicle.

The storage part of the in-vehicle device stores information concerning each of the plurality of areas different from each other but containing the common vehicle cabin inner space. The identification part of the in-vehicle device identifies the operation part having been operated among the plurality of operation parts. In accordance with which operation part has been identified by the identification part, the selection part of the in-vehicle device selects information concerning one area from the information individually concerning the plurality of areas stored in the storage part. Further, the in-vehicle device receives through the in-vehicle receiving part the response signal transmitted from the portable device. On the basis of the received signal strengths contained in the response signals received by the in-vehicle receiving part and on the basis of the information concerning the one area selected by the selection part, the determination part of the in-vehicle device determines whether the portable device is located within the one area.

When whether the portable device is located within the selected one area is determined, determination of whether the portable device is located in the inside or the outside of the vehicle cabin is allowed to be achieved. In the flowing description, the determination of whether the portable device is located in the inside or the outside of the vehicle cabin is referred to as vehicle cabin inside-or-outside determination. The in-vehicle device is allowed to select information in accordance with which operation part has been operated by the user, and perform vehicle cabin inside-or-outside determination on the basis of the selected information. This permits reduction of the time required for the vehicle cabin inside-or-outside determination. Further, for example, since the selection part selects an area generated such as to follow the outer face of the vehicle where the operation part having been operated is provided, the determination accuracy of vehicle cabin inside-or-outside determination becomes satisfactory in a case that the user owing the portable device operates the operation part.

Here, the vehicle cabin inner space of the present patent disclosure is not required to completely match the space of the vehicle cabin and is not required to completely contain the entirety of the vehicle cabin.

Further, the vehicle cabin inside-or-outside determination of the portable device is not required to be accurately performed on the entirety of the inside-outside boundary of the vehicle cabin inner space. That is, as long as a problem is not caused, an aspect that the vehicle cabin inside-or-outside determination is performed with less accuracy on a part of the inside-outside boundary may also be contained in the aspect of the present patent disclosure.

Further, a configuration that the area selected by the selection part is an area that does not follow the outer face of the operation part is also contained in the embodiment of the present patent disclosure.

(2) Such a configuration is preferable that each of the plurality of areas has a boundary that is along a part of an inner surface of the vehicle cabin, and that the selection part selects the information concerning the area having a boundary that is along a part of the inner surface corresponding to the outer face where the operation part identified by the identification part is provided.

According to the present patent disclosure, each of the plurality of areas has a boundary that follows a part of the inner surface of the vehicle cabin. The selection part selects the area having a boundary that follows a part of the inner surface of the vehicle cabin corresponding to the outer face where the operation part identified by the identification part is provided. Thus, in a case that the portable device is located in the vicinity of the operation part having been operated, the accuracy becomes satisfactory in the vehicle cabin inside-or-outside determination performed in that area.

(3) Such a configuration is preferable that the determination part is constructed such as to, on the basis of a part of the received signal strengths contained in the response signals received by the in-vehicle receiving part and on the basis of the information concerning the area selected by the selection part, determines whether the portable device is located within the area, the received signal strengths employed in the determination being different for each of the information concerning the area selected by the selection part.

According to the present patent disclosure, on the basis of a part of the received signal strengths measured by the portable device, the determination part performs the vehicle cabin inside-or-outside determination. In general, the received signal strength required for effectively performing the inside-or-outside determination of the portable device in the area varies depending on each area. Thus, the determination part performs the vehicle cabin inside-or-outside determination of the portable device by employing received signal strengths different depending on each area. When the number of received signal strengths used for vehicle cabin inside-or-outside determination is suppressed in the area corresponding to the information selected by the selection part, the time required for the vehicle cabin inside-or-outside determination is allowed to be reduced further without causing degradation in the vehicle cabin inside-or-outside determination accuracy of the portable device. The time allowed to be reduced include: the time required for transmission of a signal for received signal strength measurement from an antenna having a low-level contribution to the vehicle cabin inside-or-outside determination accuracy, measurement of the received signal strength, and transmission and reception of the measurement result of the received signal strength; and the time required for the processing of determination of an area not used in the vehicle cabin inside-or-outside determination. Here, the present aspect is not limited to a configuration that all of the individual times are allowed to be reduced. That is, a configuration that any one of the times described above is allowed to be reduced is also contained in the present aspect. Further, the number of processes required for generation of the information concerning the area stored in the storage part, that is, of the information required for determining whether the portable device is located within or without the area is allowed to be suppressed.

(4) Such a configuration is preferable that the storage part is constructed such as to store one or a plurality of antennas in correspondence to each of the operation parts, and that the in-vehicle device includes a transmission control part transmitting a signal through the one or the plurality of antennas stored in the storage part in correspondence to the operation part identified by the identification part.

According to the present patent disclosure, the storage part is constructed such as to store one or a plurality of antennas in correspondence to each of the operation parts. The transmission control part of the in-vehicle device transmits a signal through the one or the plurality of antennas stored in the storage part in correspondence to the operation part identified by the identification part. Thus, for example, in a case that antennas having a high-level contribution to the vehicle cabin inside-or-outside determination performed at the time of operation of each operation part are alone stored in advance in correspondence to each operation part, in the in-vehicle device, a signal is not transmitted from an antenna having a low-level contribution to each vehicle cabin inside-or-outside determination. Thus, without causing degradation in the vehicle cabin inside-or-outside determination accuracy of the portable device, the time required for the vehicle cabin inside-or-outside determination is allowed to be reduced further. The time allowed to be reduced include: the time required for transmission of a signal for received signal strength measurement from an antenna having a low-level contribution to the vehicle cabin inside-or-outside determination accuracy, measurement of the received signal strength, and transmission and reception of the measurement result of the received signal strength; and the time required for the processing of determination of an area not used in the vehicle cabin inside-or-outside determination. Here, the present aspect is not limited to a configuration that all of the individual times are allowed to be reduced. That is, a configuration that any one of the times described above is allowed to be reduced is also contained in the present aspect.

(5) The in-vehicle device according to an aspect of the present disclosure is an in-vehicle device, when any one of a plurality of operation parts provided in an outer face of a vehicle is operated, transmitting a signal from a plurality of antennas arranged in the vehicle and receiving a response signal transmitted from an external equipment in accordance with the signal, comprising: a storage part storing information concerning each of a plurality of areas different from each other but containing a common vehicle cabin inner space; an identification part identifying an operation part having been operated among the plurality of operation parts; a selection part, in accordance with which operation part has been identified by the identification part, selecting information concerning one area from the information individually concerning the plurality of areas stored in the storage part; an in-vehicle receiving part receiving the response signals containing received signal strengths of the signals individually transmitted from the plurality of antennas measured at the external equipment; and a determination part, on the basis of the received signal strengths contained in the response signals received by the in-vehicle receiving part and on the basis of the information concerning the one area selected by the selection part, determining whether the external equipment is located within the area.

In the present patent disclosure, when any one of the plurality of operation parts provided in the outer face of the vehicle is operated, the in-vehicle device transmits a signal from the plurality of antennas arranged in the vehicle and receives a response signal transmitted from the external equipment in accordance with the signal. The storage part of the in-vehicle device stores information concerning each of the plurality of areas different from each other but containing the common vehicle cabin inner space. The identification part of the in-vehicle device identifies the operation part having been operated among the plurality of operation parts provided in the outer face of the vehicle. In accordance with which operation part has been identified by the identification part, the selection part of the in-vehicle device selects information concerning one area from the information individually concerning the plurality of areas stored in the storage part. Further, the in-vehicle device receives through the in-vehicle receiving part the response signal transmitted from the portable device. On the basis of the received signal strengths contained in the response signals received by the in-vehicle receiving part and on the basis of the information concerning the one area selected by the selection part, the determination part of the in-vehicle device determines whether the portable device is located within the one area.

Thus, similarly to aspect (1), the in-vehicle device is allowed to select information in accordance with which operation part has been operated by the user, and perform vehicle cabin inside-or-outside determination on the basis of the selected information. This permits reduction of the time required for the vehicle cabin inside-or-outside determination. Further, for example, since the selection part selects an area generated such as to follow the outer face of the vehicle where the operation part having been operated is provided, the determination accuracy of vehicle cabin inside-or-outside determination becomes satisfactory in a case that the user owing the portable device operates the operation part.

(6) The portable device according to an aspect of the present disclosure is a portable device receiving a plurality of signals transmitted from a vehicle provided with a plurality of operation parts formed in an outer face when any one of the plurality of operation parts is operated, and transmitting response signals in accordance with the received signals, comprising: a storage part storing information concerning each of a plurality of areas different from each other but containing a common vehicle cabin inner space; an identification part, on the basis of the received signals, identifying an operation part having been operated among the plurality of operation parts; a selection part, in accordance with which operation part has been identified by the identification part, selecting information concerning one area from the information individually concerning the plurality of areas stored in the storage part; a measurement part measuring received signal strengths of the plurality of signals; and a determination part, on the basis of the received signal strengths measured by the measurement part and on the basis of the information concerning the one area selected by the selection part, determining whether itself is located within the area.

In the present patent disclosure, the portable device receives a plurality of signals transmitted from the vehicle provided with the plurality of operation parts formed in the outer face when any one of the plurality of operation parts is operated, and transmits response signals in accordance with the received signals. The storage part of the portable device stores information concerning each of the plurality of areas different from each other but containing the common vehicle cabin inner space. On the basis of the received signals, the identification part of the portable device identifies the operation part having been operated among the plurality of operation parts provided in the outer face of the vehicle. In accordance with which operation part has been identified by the identification part, the selection part of the portable device selects information concerning one area from the information individually concerning the plurality of areas stored in the storage part. Further, the measurement part of the portable device measures the received signal strengths of the plurality of received signals. On the basis of the received signal strengths measured by the measurement part and on the basis of the information concerning the one area selected by the selection part, the determination part of the portable device determines whether itself is located within the area. Thus, similarly to aspect (1), the portable device is allowed to select information in accordance with which operation part has been operated by the user, and perform vehicle cabin inside-or-outside determination on the basis of the selected information. This permits reduction of the time required for the vehicle cabin inside-or-outside determination. Further, similarly to aspect (1), for example, since the selection part selects an area generated such as to follow the outer face of the vehicle where the operation part having been operated is provided, the determination accuracy of vehicle cabin inside-or-outside determination becomes satisfactory in a case that the user owing the portable device operates the operation part.

(7) The computer program according to an aspect of the present disclosure is a computer program causing a computer to, on the basis of received signal strengths of signals which have been transmitted from a plurality of antennas arranged on a vehicle at a time that any one of a plurality of operation parts provided in an outer face of the vehicle is operated and which have been received by a portable device, determine whether the portable device is located within the vehicle cabin, wherein the computer is caused to serve as: an identification part identifying an operation part having been operated among the plurality of operation parts; a selection part, in accordance with which operation part has been identified, selecting one area from a plurality of areas different from each other but containing a common vehicle cabin inner space; and a determination part, on the basis of the received signal strengths, determining whether the portable device is located within the selected one area.

In the present patent disclosure, the computer identifies the operation part having been operated among the plurality of operation parts provided in the outer face of the vehicle. In accordance with which operation part has been identified, the computer selects one area from a plurality of areas different from each other but containing a common vehicle cabin inner space. On the basis of the received signal strengths of the signals received by the portable device, the computer determines whether the portable device is located within the selected one area. Thus, the vehicle cabin inside-or-outside determination is achieved when whether the portable device is located within the one area selected in accordance with which operation part has been operated by the user is determined. Thus, the time required for the vehicle cabin inside-or-outside determination is allowed to be reduced. Further, since an area generated such as to follow the outer face of the vehicle where the operation part having been operated is provided is selected, the determination accuracy of vehicle cabin inside-or-outside determination becomes satisfactory in a case that the user owing the portable device operates the operation part.

### Details of the Embodiments of the Present Invention

Particular examples of the vehicle-use communication system according to embodiments of the present disclosure are described below with reference to the drawings. Here, the present disclosure is not limited to these examples and is defined by the scope of the claims and intended to include all changes within the scope of the claims and the scope or the meaning equivalent thereto.

It is to be noted that, as used herein and in the appended claims, the singular forms “a”, “an”, and “the” include plural referents unless the context clearly dictates otherwise.

### Embodiment 1

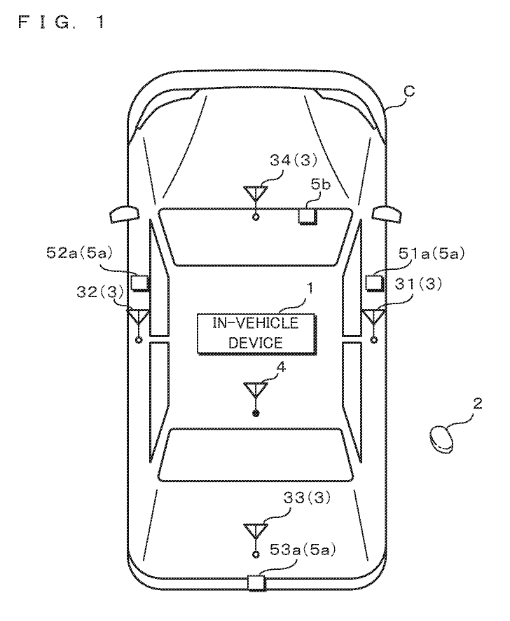

FIG. 1 is a block diagram illustrating an exemplary configuration of a vehicle-use communication system according to Embodiment 1. The vehicle-use communication system according to the present Embodiment 1 includes: an in-vehicle device 1 transmitting and receiving various signals through a plurality of transmitting antennas (3) and a receiving antenna 4 provided in a vehicle C; and a portable device 2 transmitting and receiving signals to and from the in-vehicle device 1.

For example, the plurality of transmitting antennas (3) includes: a first transmitting antenna 31 provided in a pillar on the driver side; a second transmitting antenna 32 provided in a pillar on the passenger side; a third transmitting antenna 33 provided in a back door; and a fourth transmitting antenna 34 provided in a front part of the vehicle C. The receiving antenna 4 is provided at an appropriate location of the vehicle C. Here, in the present Embodiment 1, the right side in the traveling direction of the vehicle C corresponds to the driver side and the left side in the traveling direction corresponding to the passenger side.

Further, in the vehicle C, a plurality of vehicle door request switches (5a) are provided in the outer face. Specifically, a first vehicle door request switch 51a is provided in the door handle in the outside on the driver side, a second vehicle door request switch 52a is provided in the door handle in the outside on the passenger side, and a third vehicle door request switch 53a is provided in the door handle of the back door. For example, each vehicle door request switch (5a) is constructed from: a push-type switch locking or unlocking the door having been provided; and a contact sensor detecting the contact of the user's hand with the door handle. Here, in each vehicle door request switch (5a), the configuration for locking the door having been provided and the configuration for unlocking it may be separate from each other. The vehicle door request switch (5a) corresponds to the operation part of the present patent disclosure. Further, in the vehicle C, an engine start switch 5b is provided in the vehicle cabin. For example, the engine start switch 5b is constructed from a push-type switch provided in an instrument panel located in a front part on the driver side. When the engine start switch 5b is operated, the engine is started or stopped.

When any one of the vehicle door request switches (5a) or, alternatively, the engine start switch 5b is operated, the in-vehicle device 1 successively transmits a signal used for determining the position of the portable device 2, as a radio signal from the plurality of transmitting antennas (3). The portable device 2 receives the signal transmitted from each transmitting antenna (3) and measures the received signal strength of each received signal. The portable device 2 transmits a response signal containing the measured received signal strength, as a radio signal to the in-vehicle device 1. The in-vehicle device 1 receives each response signal transmitted from the portable device 2 and then, on the basis of the received signal strengths contained in the received response signals, performs the vehicle cabin inside-or-outside determination of the portable device 2. After that, the in-vehicle device 1 executes given processing corresponding to the determination result. For example, the in-vehicle device 1 executes the processing of locking or unlocking of a vehicle door, engine start, warning of a locking failure in a vehicle door, or the like.

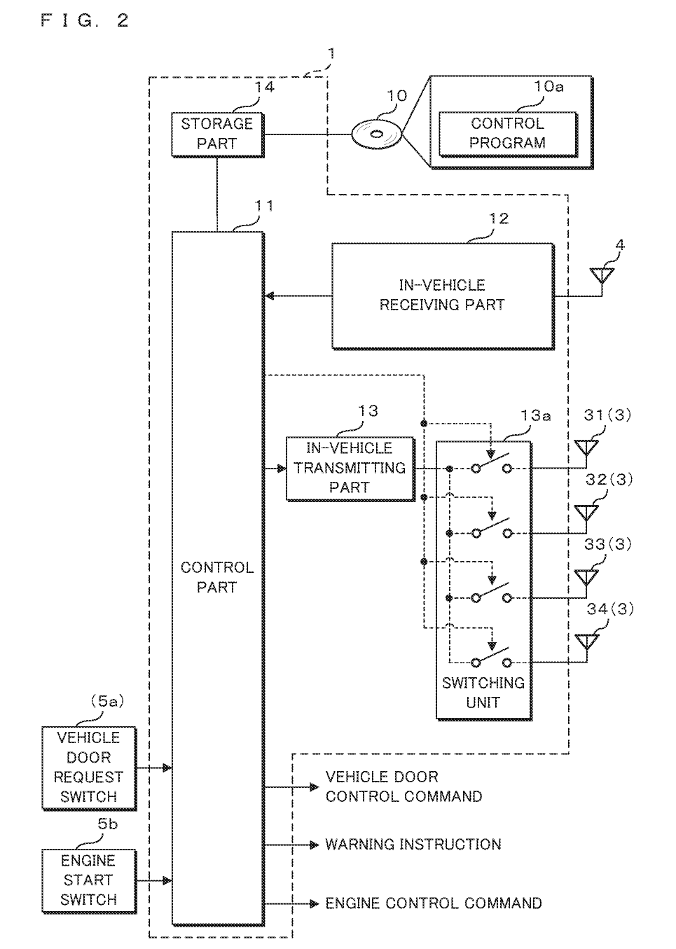

FIG. 2 is a block diagram illustrating an exemplary configuration of the in-vehicle device 1. The in-vehicle device 1 includes a control part 11 controlling the operation of each constituting part of the in-vehicle device 1. The control part 11 includes an in-vehicle receiving part 12, an in-vehicle transmitting part 13, a switching unit 13a, and a storage part 14.

For example, the control part 11 is constructed from a microcomputer including one or a plurality of CPUs (Central Processing Units), multi-core CPUs, ROMs (Read Only Memories), RAMs (Random Access Memories), input/output interfaces, timers, and the like. The CPU of the control part 11 is connected through the input/output interface to the in-vehicle receiving part 12, the in-vehicle transmitting part 13, and the storage part 14. The control part 11 executes a later-described control program 10a stored in the storage part 14 so as to control the operation of each constituting part and thereby executes vehicle cabin inside-or-outside determination of the portable device 2 and given processing corresponding to the vehicle cabin inside-or-outside determination.

The storage part 14 is constructed from a non-volatile memory such as an EEPROM (Electrically Erasable Programmable ROM) and a flash memory. The storage part 14 stores a control program 10a used for operation that the control part 11 controls the operation of each constituting part of the in-vehicle device 1 so as to execute the vehicle cabin inside-or-outside determination of the portable device 2. Further, the storage part 14 stores also various statistical values used for the vehicle cabin inside-or-outside determination of the portable device 2. Details of the statistical values are described later. Here, in FIG. 2, the control part 11 and the storage part 14 are illustrated as separate constituting parts from each other. Instead, the storage part 14 may be provided in the inside of the control part 11.

The control program 10a according to the present Embodiment 1 may be in the form of being recorded in a recording medium 10 in a computer readable manner. The storage part 14 stores the control program 10a read from the recording medium 10 by a reading device (not illustrated). The recording medium 10 is constructed from: an optical disc such as a CD (Compact Disc)-ROM, a DVD (Digital Versatile Disc)-ROM, and a BD (Blu-ray (registered trademark) Disc); a magnetic disk such as a flexible disk and a hard disk; a magneto-optical disc; a semiconductor memory; or the like. Further, the control program 10a according to the present Embodiment 1 may be downloaded from an external computer (not illustrated) connected to a communication network (not illustrated) and then may be stored into the storage part 14.

The in-vehicle receiving part 12 is connected to the receiving antenna 4. Through the receiving antenna 4, the in-vehicle receiving part 12 receives the response signal transmitted from the portable device 2 by wireless. The in-vehicle receiving part 12 is a circuit removing a carrier component from the received response signal so as to extract the received signal and then outputting the extracted received signal to the control part 11. The Ultra High Frequency band (the UHF band) from 300 MHz to 3 GHz is employed as the carrier. However, employable frequency bands are not limited to this.

The in-vehicle transmitting part 13 is a circuit that modulates a carrier with the signal outputted from the control part 11 into a radio signal and then transmits the radio signal through one transmitting antenna (3) selected by the control part 11 and the switching unit 13a to the portable device 2. The Low Frequency band (the LF band) from 30 kHz to 300 MHz is employed as the carrier. However, employable frequency bands are not limited to this.

Further, a request signal in accordance with the operating state of the vehicle door request switch (5a) is inputted to the control part 11 of the in-vehicle device 1. On the basis of the inputted request signal, the control part 11 is allowed to recognize the operating state of the vehicle door request switch (5a). Here, the control part 11 may directly acquire a request signal corresponding to the operation of the vehicle door request switch (5a) or, alternatively, may acquire the request signal through an ECU such as a door ECU (Electronic Control Unit).

In accordance with the situations such as the operating state of the vehicle door request switch (5a) and whether the portable device 2 is located within the vehicle cabin, the control part 11 outputs to a door ECU (not illustrated) a vehicle door control command of controlling the unlocking or locking of the vehicle door. In accordance with the vehicle door control command from the control part 11, the door ECU locks or unlocks the vehicle door. Further, in accordance with the situation, when required, the control part 11 outputs a warning instruction to a warning device (not illustrated). For example, when the vehicle door request switch (5a) is operated in a situation that the portable device 2 may be get locked in the vehicle cabin, the control part 11 outputs a warning instruction to the warning device. In accordance with the warning instruction, the warning device issues a given warning to the user of the vehicle C by using sound or light.

Further, an engine start signal corresponding to the operating state of the engine start switch 5b is inputted to the control part 11 of the in-vehicle device 1. On the basis of the inputted engine start signal, the control part 11 is allowed to recognize the operating state of the engine start switch 5b. In accordance with the situations such as the operating state of the engine start switch 5b and whether the portable device 2 is located in the inside of the vehicle cabin, the control part 11 outputs to an engine ECU (not illustrated) an engine control command of starting or stopping the engine. In accordance with the engine control command from the control part 11, the engine ECU starts or stops the engine.

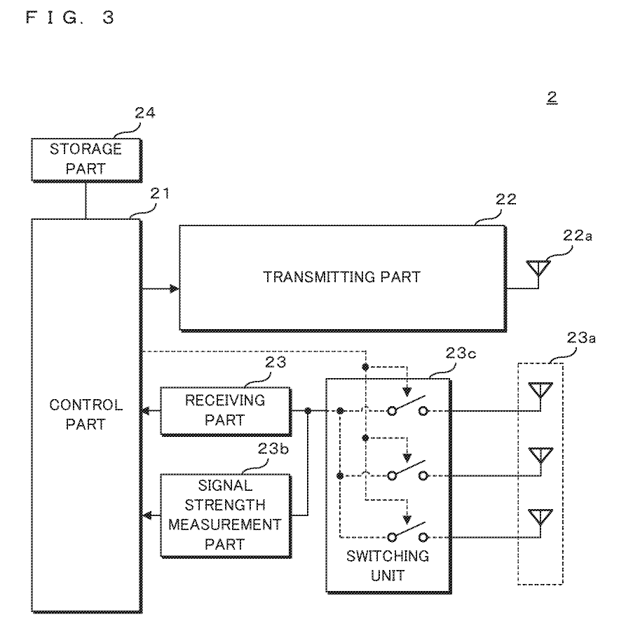

FIG. 3 is a block diagram illustrating an exemplary configuration of the portable device 2. The portable device 2 includes a control part 21 controlling the operation of each constituting part of the portable device 2. The control part 21 includes a receiving part 23, a signal strength measurement part 23b, a switching unit 23c, a transmitting part 22, and a storage part 24.

For example, the control part 21 is constructed from a microcomputer including one or a plurality of CPUs, multi-core CPUs, ROMs, RAMs, input/output interfaces, timers, and the like. The CPU of the control part 21 is connected through the input/output interface to the transmitting part 22 and the receiving part 23. The control part 21 executes a control program stored in the storage part 24 so as to control the operation of each constituting part and thereby executes various processing of transmitting information required for the vehicle cabin inside-or-outside determination of the portable device 2 to the in-vehicle device 1.

The storage part 24 is constructed from a non-volatile memory similar to the storage part 14. The storage part 24 stores the control program for operation that the control part 21 controls the operation of each constituting part of the portable device 2 so as to perform the vehicle cabin inside-or-outside determination of the portable device 2. In accordance with the control program, the control part 21 executes the processing of transmitting to the in-vehicle device 1 the response signal and the like containing the information required for the vehicle cabin inside-or-outside determination. Further, the storage part 24 stores a portable device identifier for identifying the portable device 2. Here, in FIG. 3, the control part 21 and the storage part 24 are illustrated as separate constituting parts from each other. Instead, the storage part 24 may be provided in the inside of the control part 21.

The receiving part 23 is connected through the switching unit 23c to a three-axis antenna 23a constructed such that three coils are arranged in orthogonal directions to each other. The receiving part 23 receives through the three-axis antenna 23a and the switching unit 23c the radio signal transmitted from the in-vehicle device 1. The three radio signals received by the three-axis antenna 23a are inputted into the switching unit 23c. In accordance with the control of the control part 21, the switching unit 23c selects one radio signal. The receiving part 23 is a circuit that removes a carrier component from the radio signal selected by the switching unit 23c so as to extract the received signal and then outputs the extracted received signal to the control part 21. The Low Frequency band (the LF band) from 30 kHz to 300 MHz is employed as the carrier. However, employable frequency bands are not limited to this.

Further, the portable device 2 includes the signal strength measurement part 23b that receives through the three-axis antenna 23a the radio signal transmitted from the in-vehicle device 1, then measures the received signal strength of the radio signal selected by the switching unit 23c, and then outputs to the control part 21 the measured received signal strength.

In accordance with the timing that a radio signal for signal strength measurement is transmitted from the in-vehicle device 1, the control part 21 selects each of the three radio signals from the three-axis antenna 23a and then measures the received signal strength of the selected radio signal by using the signal strength measurement part 23b. That is, in place of the received signal strength in the amplitude direction of the radio signal transmitted from the in-vehicle device 1, the control part 21 measures the components of the received signal strength in the three orthogonal directions of the three-axis antenna 23a. The control part 21 performs a vector calculation from the components of the measured received signal strength so as to calculate the received signal strength in the amplitude direction of the radio signal transmitted from the in-vehicle device 1. Thus, the control part 21 is allowed to acquire a fixed received signal strength regardless of the orientation or the attitude of the portable device 2 relative to the vehicle C. In the following description, unless otherwise mentioned in particular, the received signal strength calculated by the vector calculation is referred to as the received signal strength.

Here, an example has been described above that the control part 21 calculates the received signal strength. Instead, the received signal strength of each signal received through the three-axis antenna 23a may be transmitted from the portable device 2 to the in-vehicle device 1 and then the control part 11 of the in-vehicle device 1 may calculate the received signal strength.

The transmitting part 22 is a circuit that modulates a carrier with a response signal inputted by the control part 21 and then transmits a radio signal through a transmitting antenna 22a. The Low Frequency band (the LF band) from 30 kHz to 300 MHz is employed as the carrier. However, employable frequency bands are not limited to this.

Next, statistical values stored in the storage part 14 of the in-vehicle device 1 are described below. The storage part 14 stores statistical values setting forth a plurality of areas different from each other but each containing a common vehicle cabin inner space. In the present Embodiment 1, the storage part 14 stores statistical values setting forth three areas consisting of a first area, a second area, and a third area.

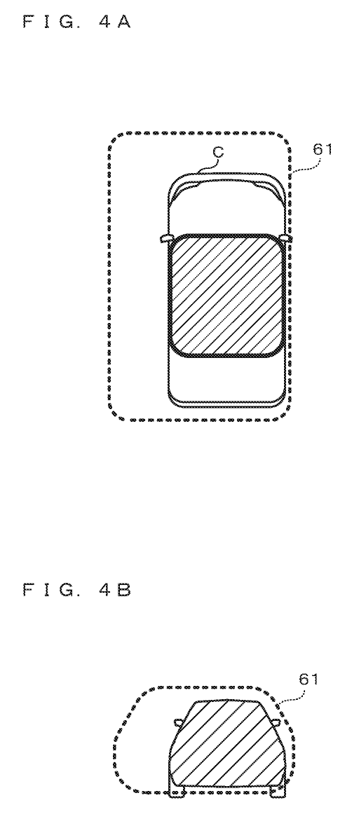

FIGS. 4A and 4B are conceptual diagrams illustrating a first area 61. FIG. 4A is a plan view of the first area 61. FIG. 4B is an elevation view of the first area 61. The first area 61 is a three-dimensional space and then, as illustrated in FIGS. 4A and 4B, has a boundary following the right inner surface of the vehicle cabin and has a shape containing the common vehicle cabin inner space. Thus, the left side wall, the rear wall, and the windshield part that constitute the vehicle cabin are also contained in the first area 61. In FIGS. 4A and 4B, the shaded portion indicates the common vehicle cabin inner space. For example, the common vehicle cabin inner space is a space where the user staying in the vehicle cabin is allowed to arrange the portable device 2.

The boundary of the first area 61 does not completely match the inner surface of the vehicle cabin. Thus, even when the inside-or-outside determination of the portable device 2 in the first area 61 is performed, the vehicle cabin inside-or-outside determination of the portable device 2 is not allowed to be accurately achieved. However, at least a part of the boundary of the first area 61 approximately matches the right inner surface of the vehicle cabin. Thus, as long as the portable device 2 is located in the vicinity of the right side wall of the vehicle C, the vehicle cabin inside-or-outside determination of the portable device 2 is allowed to be accurately achieved.

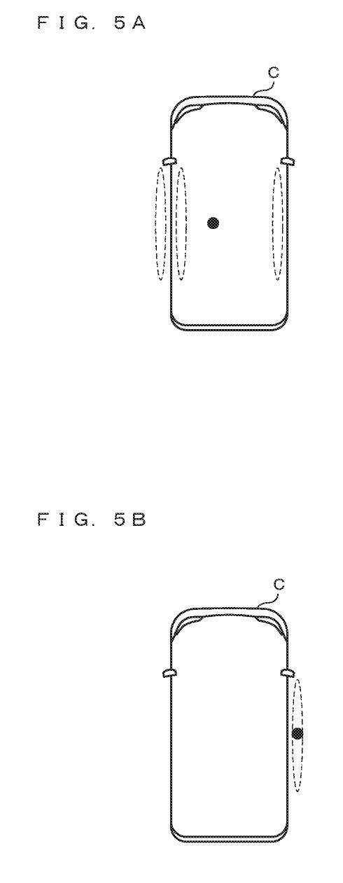

FIGS. 5A and 5B are conceptual diagrams illustrating sampling locations concerning the first area 61. The statistical values setting forth the first area 61 are calculated in the fabrication process of the vehicle-use communication system and then the storage part 14 stores the calculated statistical values. The statistical values are calculated on the basis of the sampled values of the received signal strengths measured by the portable device 2 having received each signal transmitted from the plurality of transmitting antennas (3). Here, the device measuring the sampled values of the received signal strengths may be not the portable device 2. That is, an arbitrary measuring equipment allowed to measure the strength of the signal corresponding to the received signal strength measured by the portable device 2 may be employed.

The sampled value of the received signal strength is acquired when the portable device 2 is arranged at a particular location in the inside and the outside of the vehicle C and then the received signal strength is measured. In the following description, the set of the received signal strengths measured at a plurality of locations is referred to as a sample group. As statistical values used for setting forth the first area 61, the storage part 14 stores first statistical values based on a sample group characterizing the inner side of the first area 61 and second statistical values based on a sample group characterizing the outer side of the first area 61.

FIG. 5A illustrates the arrangement of the portable device 2 used for obtaining the sampled values used for calculating the first statistical values. Specifically, the portable device 2 is arranged at a plurality of locations along the vehicle cabin inner side of the right side face of the vehicle cabin and at a plurality of locations along the vehicle cabin inner side and the vehicle cabin outer side of the left side face. Then, the received signal strength of the signal received by the portable device 2 is measured at each location. Then, the first statistical values are calculated on the basis of the sampled values of the measured received signal strengths. An ellipse of dashed line indicates a location where the portable device 2 is to be arranged.

Since four transmitting antennas (3) are employed in the present Embodiment 1, four received signal strengths are measured at one location by the portable device 2. Thus, the sample of the received signal strengths obtained at each location is of a vector quantity and hence the sample group is a group of samples each constructed from a vector. Each vector having four received signal strengths as components is referred to as the received signal strength vector.

Here, despite that the sample group is for characterizing the inner side of the first area 61, as illustrated in FIG. 5A, the sample group contains also the sampled values of the received signal strengths measured in the outside of the vehicle cabin. This is for ensuring that the first area 61 contains the entirety of the vehicle cabin inner space. In a case that the sample group does not contain the sampled values measured on the vehicle cabin inner side and the vehicle cabin outer side of the left side face, the sample group is overemphasized by the sampled values of the received signal strengths measured in the right side face of the vehicle C. When the sample group is overemphasized by the sampled values measured in the right side face of the vehicle C, the left side part of the vehicle C is dropped from the region of the first area 61 characterized by the sample group. Thus, in the present Embodiment 1, the sampled values of the received signal strengths are acquired with arranging the portable device 2 at the locations illustrated in FIG. 5A and then.

For example, the first statistical values are the mean vector and the inverse variance-covariance matrix of the sample group characterizing the inner side of the first area 61. The mean vector of the sample group is expressed by the following formulas (1) and (2). The filled circle illustrated in FIG. 5A indicates a conceptual position of the mean vector.

$$\begin{matrix}\vec{μ} = [ \begin{matrix}{μ}_{1} \\ {μ}_{2} \\ ⋮ \\ {μ}_{N}\end{matrix} ] & ( 1 ) \\ {μ}_{n} = E [ {X}_{n} ] & ( 2 )\end{matrix}$$

where
\vec{μ}: mean vector
Xₙ: sampled value of received signal strength of signal transmitted from n-th transmitting antenna
n: integer
N: number of transmitting antennas

The variance-covariance matrix of the sample group characterizing the inner side of the first area 61 is expressed by the following formulas (3) and (4). The inverse variance-covariance matrix is the inverse matrix of the variance-covariance matrix expressed by the following formula (3). The storage part 14 stores the inverse variance-covariance matrix.

$$\begin{matrix}\sum = [ \begin{matrix}{\sum }_{11} & {\sum }_{12} & … & {\sum }_{1 N} \\ ⋮ & ⋮ & … & ⋮ \\ {\sum }_{N 1} & {\sum }_{N 2} & … & {\sum }_{NN}\end{matrix} ] & ( 3 ) \\ {\sum }_{ij} = E [ ( {X}_{i} - {μ}_{i} ) ( {X}_{j} - {μ}_{j} ) ] & ( 4 )\end{matrix}$$

where
i,j: integer

FIG. 5B illustrates the arrangement of the portable device 2 used for obtaining the sampled values used for calculating the second statistical values. Specifically, the portable device 2 is arranged at a plurality of locations along the vehicle cabin outer side of the right side face of the vehicle cabin and then the received signal strength of the signal received by the portable device 2 is measured at each location. Then, the second statistical values are calculated on the basis of the sampled values of the measured received signal strengths. The second statistical values are the mean vector and the inverse variance-covariance matrix of the sample group characterizing the outer side of the first area 61. Similarly to the first statistical values, the mean vector and the inverse variance-covariance matrix constituting the second statistical values are expressed by the formulas (1) to (4) given above. The filled circle illustrated in FIG. 5B indicates a conceptual position of the mean vector of the sample group.

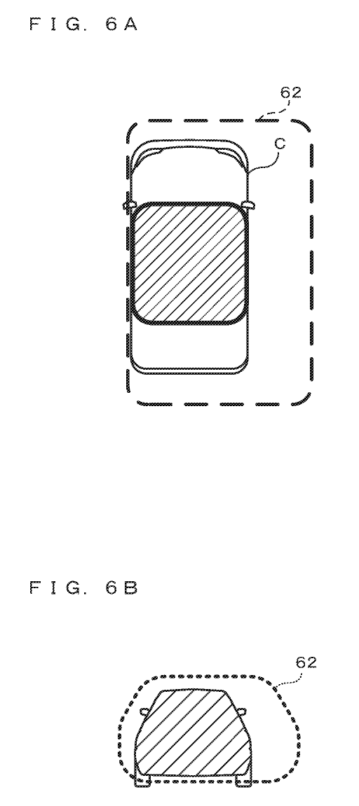

FIGS. 6A and 6B are conceptual diagrams illustrating a second area 62. FIG. 6A is a plan view of the second area 62. FIG. 6B is an elevation view of the second area 62. The second area 62 is a three-dimensional space and then, as illustrated in FIGS. 6A and 6B, has a boundary following the left side face of the vehicle cabin and has a shape containing the common vehicle cabin inner space. Thus, the right side wall, the rear wall, and the windshield part that constitute the vehicle cabin are also contained in the second area 62. In FIGS. 6A and 6B, the shaded portion indicates the common vehicle cabin inner space.

As statistical values used for setting forth the second area 62, the storage part 14 stores first statistical values based on a sample group characterizing the inner side of the second area 62 and second statistical values based on a sample group characterizing the outer side of the second area 62.

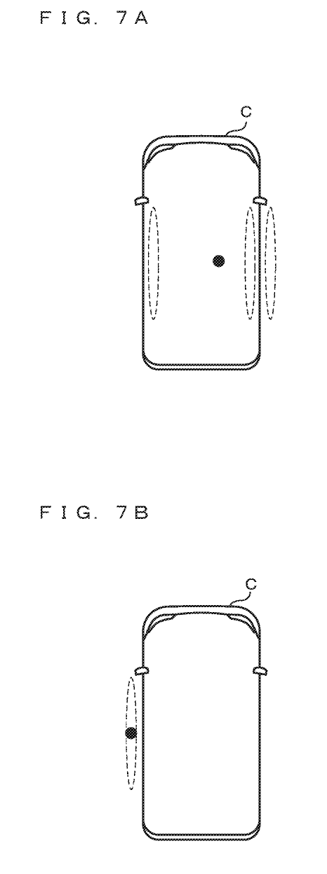

FIGS. 7A and 7B are conceptual diagrams illustrating sampling locations concerning the second area 62. The sampled values of the received signal strengths used for calculating the first statistical values and the second statistical values that set forth the second area 62 are obtained by a method that the portable device 2 is arranged at particular locations in the inside and the outside of the vehicle C illustrated in FIGS. 7A and 7B and then the received signal strengths are measured.

FIG. 7A illustrates the arrangement of the portable device 2 used for obtaining the sampled values used for calculating the first statistical values. Specifically, the portable device 2 is arranged at a plurality of locations along the vehicle cabin inner side of the left side face of the vehicle cabin and at a plurality of locations along the vehicle cabin inner side and the vehicle cabin outer side of the right side face. Then, the received signal strength of the signal received by the portable device 2 is measured at each location. Then, the first statistical values are calculated on the basis of the sampled values of the measured received signal strengths. The first statistical values are the mean vector and the inverse variance-covariance matrix of the sample group characterizing the inner side of the second area 62.

FIG. 7B illustrates the arrangement of the portable device 2 used for obtaining the sampled values used for calculating the second statistical values. Specifically, the portable device 2 is arranged at a plurality of locations along the vehicle cabin outer side of the left side face of the vehicle cabin and then the received signal strength of the signal received by the portable device 2 is measured at each location. Then, the second statistical values are calculated on the basis of the sampled values of the measured received signal strengths. Similarly to the first statistical values, the second statistical values are the mean vector and the inverse variance-covariance matrix of the sample group characterizing the outer side of the second area 62.

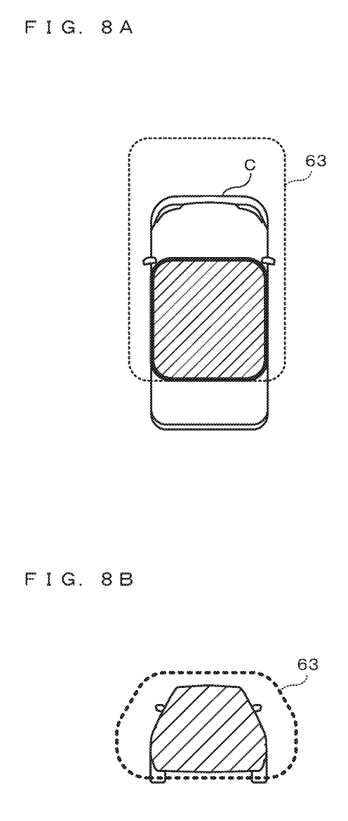

FIGS. 8A and 8B are conceptual diagrams illustrating a third area 63. FIG. 8A is a plan view of the third area 63. FIG. 8B is an elevation view of the third area 63. The third area 63 is a three-dimensional space. As illustrated in FIG. 8A, the third area 63 has a boundary following the inner face of the rear side of the vehicle cabin and has a shape containing the entirety of the common vehicle cabin inner space. In FIGS. 8A and 8B, the shaded portion indicates the common vehicle cabin inner space.

Thus, as the information concerning each of the plurality of areas different from each other but containing a common vehicle cabin inner space, the first statistical values and the second statistical values individually characterizing the first to the third area 61, 62, and 63 are stored in the storage part 14.

In the vehicle-use communication system having the above-described configuration, when any one of the first vehicle door request switch to the third vehicle door request switches 51a, 52a, and 53a is operated, the in-vehicle device 1 performs processing corresponding to the vehicle door request switch (5a) having been operated. Specifically, in accordance with which vehicle door request switch (5a) has been operated, the in-vehicle device 1 selects one area from the first to the third area 61, 62, and 63 and then executes determination of whether the portable device 2 is located within the selected area so as to perform vehicle cabin inside-or-outside determination. Specifically, in a case that the first vehicle door request switch 51a has been operated, the in-vehicle device 1 selects the first area 61 illustrated in FIGS. 4A and 4B. Further, in a case that the second vehicle door request switch 52a has been operated, the in-vehicle device 1 selects the second area 62 illustrated in FIGS. 6A and 6B. Furthermore, in a case that the third vehicle door request switch 53a has been operated, the in-vehicle device 1 selects the third area 63 illustrated in FIGS. 8A and 8B. The following description is given for a processing procedure of the vehicle-use communication system at the time that the vehicle-use communication system performs the vehicle cabin inside-or-outside determination.

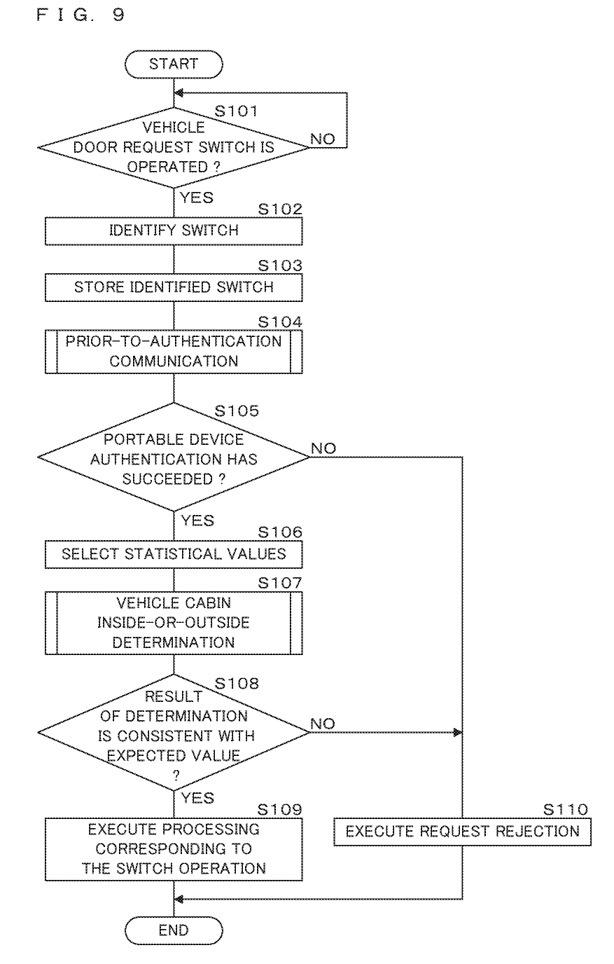

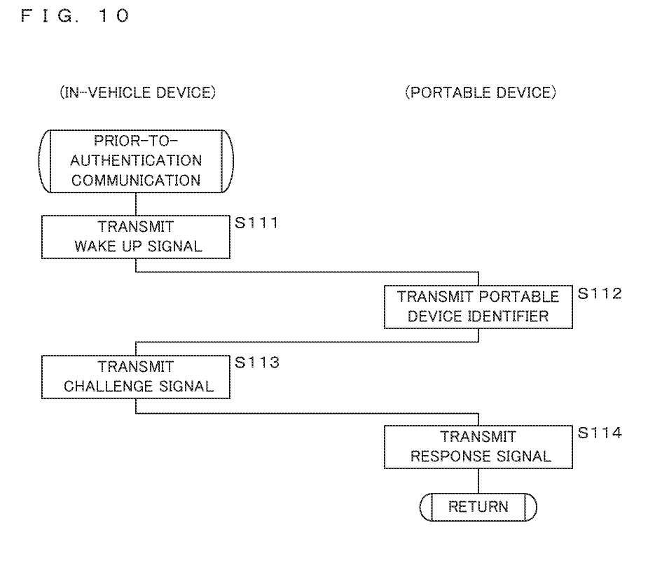

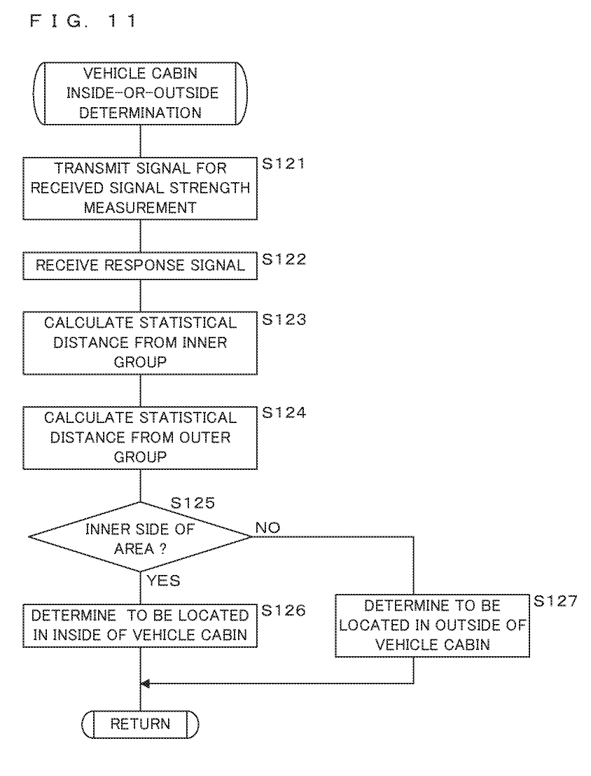

FIG. 9 is a flow chart illustrating a processing procedure at the time that the vehicle-use communication system performs the vehicle cabin inside-or-outside determination of the portable device 2. On the basis of whether a request signal has been inputted, the control part 11 of the in-vehicle device 1 determines whether the vehicle door request switch (5a) has been operated (step S101). If it is determined that the switch has not been operated (step S101: NO), the control part 11 stands by until the vehicle door request switch (5a) is operated. If it is determined that the switch has been operated (step S101: YES), the control part 11 identifies the output source of the inputted request signal so as to identify the switch having been operated (step S102). For example, the request signal may be constructed such as to contain an ID identifying the vehicle door request switch (5a) of send-out source and then, on the basis of the ID contained in the inputted request signal, the control part 11 may identify the output source of the request signal. Further, for example, the control part 11 may be constructed such that the request signal from each vehicle door request switch (5a) is inputted through each port and then, on the basis of which port the request signal is inputted through, the vehicle door request switch (5a) of output source may be identified. The control part 11 executes the control program 10a in the processing of step S102 so as to serve as the identification part. After that, the control part 11 temporarily stores the identified vehicle door request switch (5a) into the RAM provided in itself (step S103). Specifically, information such as the ID identifying the identified vehicle door request switch (5a) is temporarily stored.

Then, the control part 11 performs prior-to-authentication communication processing (step S104). The prior-to-authentication communication processing indicates communication processing started in response to operation of the vehicle door request switch (5a) and performed between the in-vehicle device 1 and the portable device 2 in order that the in-vehicle device 1 may perform authentication whether the portable device 2 of communication counterpart is authorized one. Details of this processing are described later. After that, on the basis of the prior-to-authentication communication processing, the control part 11 performs authentication of the portable device 2 (step S105).

If it is determined that the authentication has succeeded (step S105: YES), in accordance with which vehicle door request switch (5a) has been temporarily stored, the control part 11 selects the first statistical values and the second statistical values individually characterizing the inner side and the outer side of the one area, from among the statistical values stored in the storage part 14 (step S106). For example, the storage part 14 is constructed such that the first statistical values and the second statistical values individually characterizing the first to the third area 61, 62, and 63 are stored in correspondence to the ID identifying each area. At that time, in the processing of step S106, the control part 11 reads the first statistical values and the second statistical values characterizing the area a part of whose boundary matches the vehicle cabin inner surface corresponding to the outer face where the vehicle door request switch (5a) having been temporarily stored is provided, so that the selection is performed. Specifically, in a case that the vehicle door request switch (5a) having been temporarily stored is the first vehicle door request switch 51a, the control part 11 reads from the storage part 14 the first statistical values and the second statistical values characterizing the first area 61. Further, in a case that the vehicle door request switch (5a) is the second vehicle door request switch 52a, the control part 11 reads from the storage part 14 the first statistical values and the second statistical values characterizing the second area 62. Furthermore, in a case that the vehicle door request switch (5a) is the third vehicle door request switch 53a, the control part 11 reads from the storage part 14 the first statistical values and the second statistical values characterizing the third area 63. Here, the control part 11 executes the control program 10a in the processing of step S106 so as to serve as the selection part.

After the processing of step S106, the control part 11 executes the processing of vehicle cabin inside-or-outside determination by using the first statistical values and the second statistical values having been selected (step S107). That is, the control part 11 performs determination of whether the portable device 2 is located in the inside of the vehicle cabin or in the outside of the vehicle cabin. The result of vehicle cabin inside-or-outside determination is expressed by a numerical value. For example, when the portable device 2 is located in the inside of the vehicle cabin, the numerical value of the vehicle cabin inside-or-outside determination result is premised to be 1. Further, when the portable device 2 is located in the outside of the vehicle cabin, the numerical value of the vehicle cabin inside-or-outside determination result is premised to be 0.

Then, the control part 11 determines whether the result of the vehicle cabin inside-or-outside determination is consistent with an expected value set forth in advance in accordance with the contents of the operation request (step S108). For example, the expected value corresponding to the operation of unlocking the vehicle door based on the operation of the vehicle door request switch is set to be 0.

If it is determined that the result of vehicle cabin inside-or-outside determination is consistent with the expected value (step S108: YES), the control part 11 executes the processing corresponding to the switch operation of the vehicle door request switch (5a) (step S109). For example, the in-vehicle device 1 executes the processing of outputting to the door ECU a vehicle door control signal instructing the locking or unlocking of the vehicle door.

If it is determined that the result of the vehicle cabin inside-or-outside determination is not consistent with the expected value (step S108: NO) or, alternatively, if it is determined that the authentication of the portable device 2 has been failed (step S105: NO), the control part 11 executes the processing of request rejection (step S110), and then terminates the processing. The processing of request rejection indicates processing of not responding to the switch operation of the vehicle door request switch (5a) and, for example, of generating a warning beep when the portable device 2 is not located in the outside of the vehicle cabin. By virtue of the processing, for example, position check of the portable device 2 in order that lock-in of the portable device 2 in the vehicle cabin may be avoided is allowed to be achieved. Here, the processing of request rejection is not indispensable.

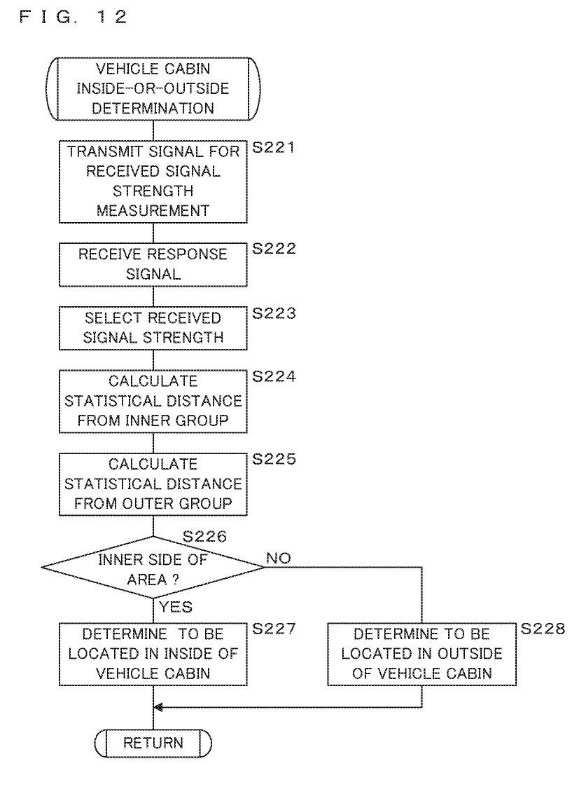

FIG. 10 is a flow chart illustrating a subroutine of prior-to-authentication communication processing. The control part 11 of the in-vehicle device 1 causes the in-vehicle transmitting part 13 to transmit a wake up signal from the transmitting antenna (3) (step S111).

The control part 21 of the portable device 2 having received the wake up signal in the receiving part 23 starts up from a sleep state into an active state and then transmits an own portable device identifier from the transmitting part 22 to the in-vehicle device 1 (step S112).

The control part 11 of the in-vehicle device 1 receives through the in-vehicle receiving part 12 the portable device identifier transmitted from the portable device 2. Then, by using the received portable device identifier, the control part 11 generates data for authentication and then causes the in-vehicle transmitting part 13 to transmit a challenge signal containing the data from the transmitting antenna (3) (step S113).

The control part 21 receives the challenge signal through the receiving part 23. Then, by using the data contained in the received challenge signal, the control part 21 checks the validity of the in-vehicle device 1. If the validity of the in-vehicle device 1 is concluded, the control part 21 generates data used for authentication of the portable device 2 by the in-vehicle device 1, and then transmits a response signal containing the data from the transmitting part 22 to the in-vehicle device 1 (step S114). After that, the subroutine of prior-to-authentication communication processing in the vehicle-use communication system is terminated. Then, on the basis of the data contained in the response signal transmitted at step S114, the control part 11 of the in-vehicle device 1 at step S105 performs authentication of the portable device 2.

FIG. 11 is a flow chart illustrating a subroutine of vehicle cabin inside-or-outside determination processing. The control part 11 of the in-vehicle device 1 causes the in-vehicle transmitting part 13 to successively transmit a signal for received signal strength measurement used for the vehicle cabin inside-or-outside determination from each of the plurality of transmitting antennas (3) (step S121).

The control part 21 of the portable device 2 receives through the receiving part 23 the signal transmitted from each transmitting antenna (3) and then acquires the received signal strength of each signal measured by the signal strength measurement part 23b. Then, the control part 21 transmits a response signal containing the measured received signal strength, through the transmitting part 22 to the in-vehicle device 1.

The control part 11 of the in-vehicle device 1 receives through the in-vehicle receiving part 12 the response signal transmitted from the portable device 2 (step S122). Then, on the basis of the received signal strengths contained in the response signals received by the in-vehicle receiving part 12 and on the basis of the first statistical values selected at step S106 in FIG. 9, the control part 11 calculates a statistical distance between the received signal strengths and the sample group concerning the first statistical values (step S123). In a case that the first statistical values of the first area 61 have been selected at step S106, the control part 11 calculates a statistical distance between the received signal strengths contained in the response signals and the sample group characterizing the inner side of the first area 61. The statistical distance is the Mahalanobis distance. The Mahalanobis distance is expressed by the following formula (5).

D²=(\vec{χ}−\vec{μ})^{T}·Σ⁻¹·(\vec{χ}−\vec{μ}) (5)

where
D: Mahalanobis distance
\vec{χ}: received signal strength vector
\vec{μ}: mean vector
Σ⁻¹: inverse variance-covariance matrix

$$\vec{χ} = [ \begin{matrix}{χ}_{1} \\ {χ}_{2} \\ ⋮ \\ {χ}_{N}\end{matrix} ] \qquad ( 6 )$$

where
χₙ: received signal strength of signal transmitted from n-th transmitting antenna

Then, on the basis of the received signal strengths contained in the response signals received at step S122 and on the basis of the second statistical values selected at step S106, the control part 11 calculates a statistical distance between the received signal strengths and the sample group concerning the second statistical values (step S124). In a case that the second statistical values of the first area 61 have been selected at step S106, the control part 11 calculates a statistical distance between the received signal strengths contained in the response signals and the sample group characterizing the outer side of the first area 61. For example, the statistical distance is the Mahalanobis distance.

Then, the control part 11 compares the statistical distance calculated at step S123 with the statistical distance calculated at step S124 so as to determine whether the portable device 2 is located within the one area corresponding to the statistical values selected at step S106 (step S125). For example, if the statistical distance from the sample group characterizing the inner side of the first area 61 is shorter than the statistical distance from the sample group characterizing the outer side of the first area 61, the control part 11 determines that the portable device 2 is located within the first area 61. For example, if the statistical distance from the sample group characterizing the outer side of the first area 61 is shorter than the statistical distance from the sample group characterizing the inner side of the first area 61, the control part 11 determines that the portable device 2 is located on the outer side of the first area 61. The control part 11 executes the control program 10a in the processing of step S125 so as to serve as the determination part.

If it is determined that the portable device 2 is located within the one area (step S125: YES), the control part 11 determines that the portable device 2 is located in the inside of the vehicle cabin (step S126), and then terminates the processing of the subroutine.

If it is determined that the portable device 2 is located on the outer side of the one area (step S125: NO), the control part 11 determines that the portable device 2 is located in the outside of the vehicle cabin (step S127), and then terminates the processing of the subroutine.

On the other hand, similarly to a case that the vehicle door request switch (5a) has been operated, in a case that the engine start switch 5b has been operated, the in-vehicle device 1 determines the present position of the portable device 2. At that time, the in-vehicle device 1 performs processing similar to that illustrated in FIGS. 9 to 11. Thus, their differences are described below.

In place of the processing of step S101 in FIG. 9, the control part 11 of the in-vehicle device 1 determines whether the engine start switch 5b has been operated. If it is not determined that the switch has been operated, the control part 11 stands by until the switch is operated. If it is determined that the switch has been operated, the control part 11 performs processing similar to step S104 to step S110. At the time that the control part 11 performs the processing corresponding to step S106, a part or all of the statistical values characterizing the first to the third area 61, 62, and 63 may be selected or, alternatively, statistical values characterizing a different area may be stored in the storage part 14 and then the selection may be performed such that the statistical values may be contained. For example, this different area indicates a three-dimensional space that has a boundary following the inner face on the front side of the vehicle cabin and that has a shape containing the entirety of the common vehicle cabin inner space.

In a case that the statistical values characterizing one area are selected alone, as the processing corresponding to step S107, the control part 11 performs processing similar to the subroutine illustrated in FIG. 11 on the basis of the statistical values having been selected. In a case that a plurality of statistical values are selected, as the processing corresponding to step S107, the control part 11 performs processing similar to step S123 to step S125 in FIG. 11 for the individual statistical values characterizing each area. At that time, in the processing corresponding to step S125, in the in-vehicle device 1, if it is determined that the portable device 2 is located within every one of all the plurality of areas, it is determined that that the portable device 2 is located within the vehicle cabin. Otherwise, it is determined that the portable device 2 is located in the outside of the vehicle cabin.

In the processing corresponding to step S109, for example, the in-vehicle device 1 executes the processing of outputting to the engine ECU an engine control command of starting or stopping the engine. In the processing corresponding to step S110, for example, the in-vehicle device 1 performs the processing of generating a warning beep if the portable device 2 is not located within the vehicle cabin. Here, the processing corresponding to step S110 is not indispensable.

When the engine start switch 5b has been operated, the in-vehicle device 1 performs the above-described processing so as to achieve, for example: checking of whether the portable device 2 is located within the vehicle cabin at the time of motor starting; and checking of whether the portable device 2 is staying within the vehicle cabin during motor operation.

In the above-described vehicle-use communication system, the in-vehicle device 1 selects the statistical values at step S106 on the basis of the switch identified at step S102 in FIG. 9 and is then allowed to determine the present position of the portable device 2 on the basis of the statistical values and the received signal strengths contained in the received response signals. The statistical values are information concerning one area among the first to the third area 61, 62, and 63. Thus, the in-vehicle device 1 determines whether the portable device 2 is located on the inner side of only the one area corresponding to the statistical values having been selected, so that the vehicle cabin inside-or-outside determination is achieved. Thus, the time required for the vehicle cabin inside-or-outside determination is allowed to be reduced in comparison with a case that whether the portable device 2 is located on the inner side is determined for each of the first to the third area 61, 62, and 63. Further, in a case that the operator of the vehicle door request switch (5a) carries the portable device 2, the portable device 2 is located in the vicinity of the vehicle door request switch (5a). Thus, when the in-vehicle device 1 selects an area a part of whose boundary follows the vehicle cabin inner surface corresponding to the outer face of the vehicle C where the vehicle door request switch (5a) having been operated is provided, the vehicle cabin inside-or-outside determination accuracy becomes satisfactory.

Here, the in-vehicle device 1 in Embodiment 1 may select the statistical values concerning an area a part of whose boundary follows a vehicle cabin inner surface different from the vehicle cabin inner surface corresponding to the outer face of the vehicle C where the vehicle door request switch (5a) having been operated is provided. For example, in a case that the second vehicle door request switch 52a provided on the passenger side has been operated, the in-vehicle device 1 may select the statistical values characterizing the first area 61. In this case, the vehicle cabin inside-or-outside determination accuracy concerning the portable device 2 becomes satisfactory in a case that the driver different from the operator of the vehicle door request switch (5a) carries the portable device 2.

Further, plural sets of statistical values may be selected in accordance with which vehicle door request switch (5a) has been operated. For example, in addition to the statistical values characterizing the one area selected at step S106 in FIG. 9, the in-vehicle device 1 may select the statistical values characterizing the first area 61. At that time, the in-vehicle device 1 executes the processing of steps S123 to 125 in FIG. 11 for each set of the statistical values characterizing each selected area. Then, if it is determined that the portable device 2 is located within both of the one area and the first area 61, it is determined that the portable device 2 is located within the vehicle cabin. Otherwise, it is determined that the portable device 2 is located in the outside of the vehicle cabin. By virtue of the above-described processing, in a case that the driver carries the portable device 2, the vehicle cabin inside-or-outside determination accuracy concerning the portable device 2 becomes more satisfactory. Further, determination of whether the portable device 2 is located in the inside is required not for all areas and hence the time required for the vehicle cabin inside-or-outside determination is allowed to be reduced.

Further, when the first area 61 having a boundary that follows the right inner surface of the vehicle cabin and the second area 62 having a boundary that follows the left inner surface are employed, the vehicle cabin inside-or-outside determination of the portable device 2 is allowed to be accurately performed in the right side face and the left side face of the vehicle cabin.

Furthermore, when the third area 63 having a boundary that follows the inner face on the rear side of the vehicle cabin is employed, the vehicle cabin inside-or-outside determination of the portable device 2 in the rear face of the vehicle cabin is allowed to be accurately performed.

Further, the in-vehicle device 1 performs the vehicle cabin inside-or-outside determination of the portable device 2 by using the first statistical values and the second statistical values individually characterizing the inner side and the outer side of the first area 61 and the second area 62. As illustrated in FIGS. 5A and 5B and FIGS. 7A and 7B, the first statistical values and the second statistical values are calculated on the basis of the sample groups of the received signal strengths measured at a plurality of locations along the vehicle cabin inner side and the vehicle cabin outer side of the right inner surface and the left inner surface of the vehicle C. When the above-described sample groups are employed as the sample groups for calculating the first statistical values and the second statistical values, the number of processes required for generation of the statistical values used for determining whether the portable device 2 is located within each of the first area 61 and the second area 62 is effectively suppressed in comparison with a case that a huge sample group is generated at random.

Here, Embodiment 1 has been described for an example that the received signal strengths of the sample groups used for calculating the first statistical values and the second statistical values individually characterizing the inner side and the outer side of the first area 61 and the second area 62 are measures at the locations illustrated in FIGS. 5A and 5B and FIGS. 7A and 7B. However, these measurement locations are exemplary. For example, as for the sample group used for calculating the first statistical values concerning the first area 61, it is sufficient that the received signal strengths are measured at least at a plurality of locations along the vehicle cabin inner side of the right side face of the vehicle cabin and at a plurality of locations along the vehicle cabin outer side so that the first area 61 contains the common vehicle cabin inner space. Further, a similar situation holds also for the second area 62 and the third area 63.

Even in a case that the first statistical values and the second statistical values obtained by the method described above are employed, similar effects to those of the vehicle-use communication system described above are obtained.

Further, the in-vehicle device 1 may calculate the statistical distance from each of the sample groups characterizing the inner side and the outer side of the first to the third area 61, 62, and 63, on the basis of the first statistical values and the second statistical values and then may compare the calculated statistical distances with each other so as to perform the vehicle cabin inside-or-outside determination of the in-vehicle device 1. Specifically, the vehicle cabin inside-or-outside determination of the portable device 2 is allowed to be accurately performed by employing simple arithmetic operation such as the calculation of the Mahalanobis distance and the comparison of the Mahalanobis distances.

Here, Embodiment 1 has been described for an example that the determination of whether the portable device 2 is located on the inner side of each of the first to the third area 61, 62, and 63 is performed by employing the Mahalanobis distance. However, the Mahalanobis distance is an example of the statistical distance. Any other arbitrary statistical values such as the statistical distance and the similarity may be employed as long as the degree of approximation between the measured received signal strengths and a particular sample group is allowed to be determined.

Further, an example has been described that one area is selected from the first to the third area 61, 62, and 63 in accordance with which vehicle door request switch (5a) has been operated and then determination of whether the portable device 2 is located within the selected area is performed so that the vehicle cabin inside-or-outside determination is achieved. However, the first to the third area 61, 62, and 63 are exemplary. Arbitrary modification may be made to the vehicle-use communication system as long as a configuration is employed that performs determination of whether the portable device 2 is located within an area having a boundary that follows a part of the inner face of the vehicle cabin inner space. For example, the vehicle cabin inside-or-outside determination of the portable device 2 may be performed by using any two of the first to the third area 61, 62, and 63 in accordance with which vehicle door request switch (5a) has been operated. Further, the vehicle cabin inside-or-outside determination of the portable device 2 may be performed by employing other two or more areas each having a shape different from those of the present Embodiment 1.

Further, the vehicle-use communication system of the present Embodiment 1 has been described for an example that the storage part 14 stores the mean vector and the inverse variance-covariance matrix as the statistical values characterizing the inner side and the outer side of the first to the third area 61, 62, and 63. These statistical values are exemplary. That is, the contents and the method of storing are not limited to particular ones as long as the information permits determination of whether the portable device 2 is located within each area. For example, the storage part 14 may store the mean vector and the variance-covariance matrix or, alternatively, may store the sample group itself. Further, the information such as the statistical values may be stored in the storage part 14 as information having a different form from the control program 10a, alternatively, may be information incorporated into the control program 10a.

Furthermore, the locations of sampling the sample groups illustrated in FIGS. 5A and 5B and FIGS. 7A and 7B are exemplary. That is, the statistical values of each area may be calculated by using a sample group of the received signal strengths measured at any other location as long as an area is allowed to be set forth such as to have a boundary that follows a part of the inner face of the vehicle cabin inner space and contain the entirety of the vehicle cabin inner space.

(Modification 1)

Embodiment 1 has been described for an example that the in-vehicle device 1 performs the vehicle cabin inside-or-outside determination of the portable device 2. Instead, a configuration may be employed that the portable device 2 itself performs the vehicle cabin inside-or-outside determination. The configuration of the vehicle-use communication system according to Modification 1 is similar to the configuration of Embodiment 1 and hence the in-vehicle device 1 and the portable device 2 are provided. In the portable device 2 of Modification 1, the storage part 24 stores the first statistical values and the second statistical values that set forth the first to the third area 61, 62, and 63; and a computer program of the present patent disclosure.

In the vehicle-use communication system of Modification 1, the processing of step S106 described in FIG. 9 and the processing of step S107, i.e., step S121 to step S127 in FIG. 11, are suitably executed by the control part 21 of the portable device 2 so that the vehicle cabin inside-or-outside determination result is transmitted to the in-vehicle device 1. The detailed processing procedure is as follows.

If it is determined that authentication of the portable device 2 has succeeded at step S105 (step S105: YES), the control part 11 of the in-vehicle device 1 causes in-vehicle transmitting part 13 to successively transmit a signal for received signal strength measurement used for the vehicle cabin inside-or-outside determination from each of the plurality of transmitting antennas (3). At that time, the control part 11 include the information concerning the vehicle door request switch (5a) stored at step S103, into the signal to be transmitted.

The control part 21 of the portable device 2 receives through the receiving part 23 the signal transmitted from each transmitting antenna (3) and then acquires the received signal strength of each signal measured by the signal strength measurement part 23b. Further, on the basis of the information concerning the vehicle door request switch (5a) contained in the signal received by the receiving part 23, the control part 21 of the portable device 2 identifies the vehicle door request switch (5a) having been operated. At that time, the control part 21 executes the computer program of the present patent disclosure stored in the storage part 24 so as to serve as the identification part.

Then, in accordance with which vehicle door request switch (5a) has been identified, the control part 21 selects the first statistical values and the second statistical values individually characterizing the inner side and the outer side of the one area, from among the statistical values stored in the storage part 24. The control part 21 performs processing similar to the processing performed by the in-vehicle device 1 at step S106 in FIG. 9, so as to select the first statistical values and the second statistical values. At that time, the control part 21 executes the computer program of the present patent disclosure stored in the storage part 24 so as to serve as the selection part.

Then, the control part 21 calculates a statistical distance between the measured received signal strengths and the sample group concerning the selected first statistical values. Further, the control part 21 calculates a statistical distance between the measured received signal strengths and the sample group concerning the selected second statistical values. The control part 21 compares the calculated statistical distances with each other so as to determine whether the portable device 2 is located within the one area characterized by the first statistical values and the second statistical values having been selected. If it is determined that the portable device 2 is located within the area, the control part 21 determines that the portable device 2 is located within the vehicle cabin. Then, if it is determined that the portable device 2 is located on the outer side of the area, the control part 21 determines that the portable device 2 is located in the outside of the vehicle cabin. At that time, the control part 21 executes the computer program stored in the storage part 24 so as to serve as the determination part.

After that, the control part 21 transmits a response signal containing the determination result of whether the portable device 2 is located in the inside or the outside of the vehicle cabin, through the transmitting part 22 to the in-vehicle device 1. The in-vehicle device 1 receives the response signal transmitted from the portable device 2 and then, in accordance with the vehicle cabin inside-or-outside determination result contained in the received response signal, executes given processing. For example, the in-vehicle device 1 executes the processing of locking or unlocking of the vehicle door.

According to Modification 1, similarly to Embodiment 1, determination of whether the portable device 2 is located within one area corresponding to the vehicle door request switch (5a) having been operated among the first to the third area 61, 62, and 63 is performed so that the vehicle cabin inside-or-outside determination of the portable device 2 is allowed to be achieved. Thus, the time required for the vehicle cabin inside-or-outside determination is allowed to be reduced. Further, the other effects are also similar to those of Embodiment 1.

### Embodiment 2

In a vehicle-use communication system according to Embodiment 2, vehicle cabin inside-or-outside determination is performed by employing a part of received signal strengths suitable for the vehicle cabin inside-or-outside determination of the portable device 2 performed in accordance with which vehicle door request switch (5a) has been operated, among the received signal strengths contained in the response signals. In the vehicle-use communication system and the computer program according to Embodiment 2, the contents of the statistical values stored in the storage part 14 of the in-vehicle device 1 and the processing procedure of the control part 11 are different from those of Embodiment 1. Thus, the following description is given mainly for these differences. The other configurations and operation effects are similar to those of Embodiment 1. Thus, corresponding parts are designated by like numerals and then detailed description is not given.

Similarly to Embodiment 1, the storage part 14 stores the first statistical values and the second statistical values as information concerning each of the first to the third area 61, 62, and 63. However, the received signal strengths of the sample group used for calculation of the individual statistical values are different depending on each area. For example, the received signal strength vector has four received signal strengths. However, some received signal strengths improve the accuracy of the vehicle cabin inside-or-outside determination of the portable device 2 in the first area 61, some received signal strengths have no influence, and some received signal strengths degrade the accuracy of the vehicle cabin inside-or-outside determination. Thus, the storage part 14 stores the first statistical values and the second statistical values calculated by using different received signal strengths for each of the first to the third area 61, 62, and 63. For example, as for the first area 61, the first statistical values and the second statistical values are calculated by using the received signal strengths of the signals transmitted from the second transmitting antenna 32, the third transmitting antenna 33, and the fourth transmitting antenna 34. Further, the storage part 14 stores information indicating which received signal strengths among the four kinds of received signal strengths are to be employed for the vehicle cabin inside-or-outside determination of the portable device 2 for each of the first to the third area 61, 62, and 63.

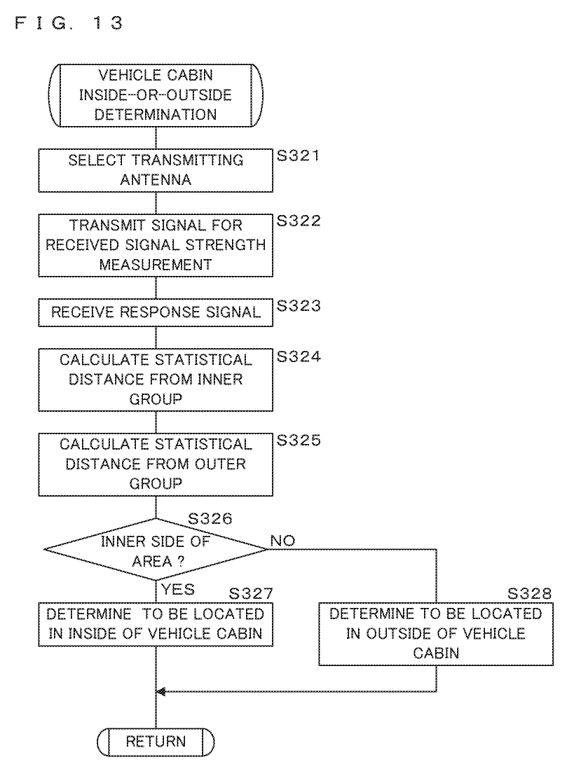

FIG. 12 is a flow chart illustrating the processing of vehicle cabin inside-or-outside determination subroutine in Embodiment 2. At step S221 to step S222, the in-vehicle device 1 and the portable device 2 execute processing (step S121 to step S122) concerning the measurement of the received signal strength and the receiving of the response signal similar to those of Embodiment 1.

Then, the control part 11 of the in-vehicle device 1 selects components to be used for determination of whether the portable device 2 is located within the one area characterized by the statistical values selected at step S106 in FIG. 9, from among the received signal strengths contained in the response signals (step S223). Then, by using the received signal strengths selected at step S223, processing (step S123 to step S127) similar to Embodiment 1 concerning the vehicle cabin inside-or-outside determination such as the determination of whether the portable device 2 is located within the one area is executed at step S224 to step S228.

As described above, the vehicle-use communication system and the in-vehicle device 1 of Embodiment 2 have a configuration that determination of whether the portable device 2 is located within the selected one area is performed by using a part of the components of the received signal strength vector. Thus, the vehicle cabin inside-or-outside determination of the portable device 2 is allowed to be efficiently performed. Further, when the components of the received signal strength vector to be used are reduced, the number of generation processes of the statistical values used for the determination of whether the portable device 2 is located within the one area, without causing degradation in the accuracy of the vehicle cabin inside-or-outside determination of the portable device 2.

(Modification 2)

Embodiment 2 has been described for an example that the in-vehicle device 1 performs the vehicle cabin inside-or-outside determination of the portable device 2. Instead, a configuration may be employed that the portable device 2 itself performs the vehicle cabin inside-or-outside determination. The configuration of the vehicle-use communication system according to Modification 2 is similar to the configuration of Embodiment 2 and hence the in-vehicle device 1 and the portable device 2 are provided. In the portable device 2, the storage part 24 stores: the first statistical values and the second statistical values that set forth the first to the third area 61, 62, and 63; information indicating which received signal strengths are to be used for own vehicle cabin inside-or-outside determination among the four kinds of received signal strengths of each area; and a computer program of the present patent disclosure. In the vehicle-use communication system of Modification 2, similarly to Modification 1, the processing of step S106 described in FIG. 9 and the processing of step S107, i.e., step S221 to step S228 in FIG. 12, are suitably executed by the control part 21 of the portable device 2 so that the vehicle cabin inside-or-outside determination result is transmitted to the in-vehicle device 1.

According to Modification 2, similarly to Embodiment 2, a configuration is employed that the inside-or-outside determination in each area is performed by using a part of the components of the received signal strength vector. Thus, the vehicle cabin inside-or-outside determination of the portable device 2 is allowed to be efficiently performed. The other effects are similar to those of Embodiments 1 and 2.

### Embodiment 3

In a vehicle-use communication system according to Embodiment 3, vehicle cabin inside-or-outside determination of the portable device 2 is performed in a state that the combination of the transmitting antennas (3) from which a signal for received signal measurement is transmitted is changed in accordance with which vehicle door request switch (5a) has been operated. In the vehicle-use communication system and the computer program according to Embodiment 3, the contents stored in the storage part 14 of the in-vehicle device 1 and the processing procedure of the control part 11 are different from those of Embodiment 2. Thus, the following description is given mainly for these differences. The other configurations and operation effects are similar to those of Embodiment 2. Thus, corresponding parts are designated by like numerals and then detailed description is not given.

In Embodiment 2 given above, a configuration has been described that the storage part 14 stores information indicating which received signal strengths are to be used for the vehicle cabin inside-or-outside determination of the portable device 2, among the four kinds of received signal strengths for each of the first to the third area 61 and 62, and 63. In Embodiment 3, in place of this information, the storage part 14 stores in correspondence to each other: information identifying each vehicle door request switch (5a); and a set of information identifying the transmitting antenna (3) through which a signal for received signal strength measurement is to be transmitted from the in-vehicle device 1 to the portable device 2. For example, the set of the first transmitting antenna 31 and the second transmitting antenna 32, the set of the second transmitting antenna to the fourth transmitting antenna 32, 33, and 34, and the set of the third transmitting antenna 33 and the fourth transmitting antenna 34 are stored in correspondence to the first vehicle door request switch 51a. Further, for example, the set of the first transmitting antenna 31 and the second transmitting antenna 32, the set of the first transmitting antenna 31, the third transmitting antenna 33, and the fourth transmitting antenna 34, and the set of the third transmitting antenna 33 and the fourth transmitting antenna 34 are stored in correspondence to the second vehicle door request switch 52a. Furthermore, for example, the set of the second transmitting antenna to the fourth transmitting antenna 32, 33, and 34, the set of the third transmitting antenna 33 and the fourth transmitting antenna 34, and the set of the first transmitting antenna 31 and the second transmitting antenna 32 are stored in correspondence to the third vehicle door request switch 53a. Here, as for the sets of the transmitting antennas (3) corresponding to each vehicle door request switch (5a), all of the above-described examples may be stored or, alternatively, a part thereof may be stored. Further, a priority may be imparted to each set of the transmitting antennas (3) in the above-described order and then may be stored in correspondence to each vehicle door request switch (5a).

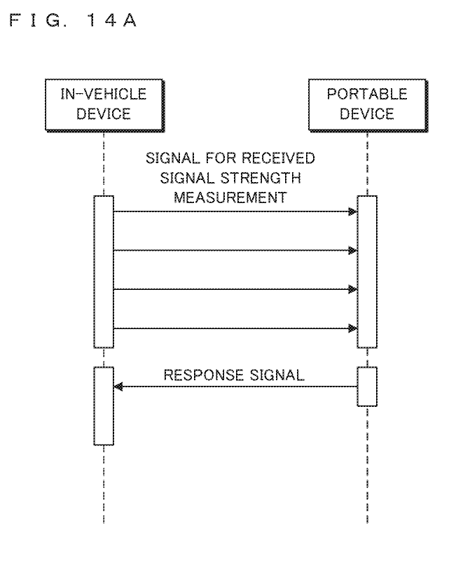

FIG. 13 is a flow chart illustrating the processing of a vehicle cabin inside-or-outside determination subroutine in Embodiment 3. In accordance with which vehicle door request switch (5a) has been operated, the control part 11 of the in-vehicle device 1 selects the transmitting antenna (3) from which a signal for received signal strength measurement is to be transmitted (step S321). Specifically, the control part 11 reads from the storage part 14 the information identifying the transmitting antenna (3) corresponding to the information that identifies the vehicle door request switch (5a) stored at step S103 in FIG. 9, so that the selection is achieved. For example, in a case that plural sets of information identifying the transmitting antenna (3) are stored in correspondence to the information identifying the vehicle door request switch (5a), information identifying the transmitting antenna (3) concerning one set is read. The condition used for selecting the one set is an arbitrary condition such as the priority.

After that, the control part 11 transmits a signal for received signal strength measurement from the selected transmitting antenna (3) to the portable device 2 (step S322) and then the in-vehicle receiving part 12 receives a response signal transmitted from the portable device 2 in response to the transmission of the signal (step S323). After that, processing (step S224 to step S228) similar to Embodiment 2 is executed at step S324 to step S328. The control part 11 executes the control program 10a in the processing of step S321 and step S322 so as to serve as the transmission control part.

As described above, according to the vehicle-use communication system and the in-vehicle device 1 of Embodiment 3, the storage part 14 stores in advance in a correspondence manner the set of the transmitting antennas (3) having a high-level contribution to the vehicle cabin inside-or-outside determination performed at the time that the vehicle door request switch (5a) is operated. Thus, the in-vehicle device 1 does not transmit a signal from the transmitting antenna (3) having a low-level contribution to each vehicle cabin inside-or-outside determination. Accordingly, without causing degradation in the vehicle cabin inside-or-outside determination accuracy of the portable device 2, the time required for the vehicle cabin inside-or-outside determination is allowed to be reduced further. Specifically, in the in-vehicle device 1, the time such as: the time required for transmission of a signal for received signal strength measurement from the transmitting antenna (3) having a low-level contribution to the vehicle cabin inside-or-outside determination accuracy, measurement of the received signal strength, and transmission and reception of the measurement result of the received signal strength; and the time required for the processing of determination of an area not used in the vehicle cabin inside-or-outside determination; is allowed to be reduced. Here, the present embodiment is not limited to a configuration that all of the individual times are allowed to be reduced. That is, a configuration that any one of the times described above is allowed to be reduced is also contained in the present embodiment.

The situation that the time required for the vehicle cabin inside-or-outside determination is allowed to be reduced is described below in detail.

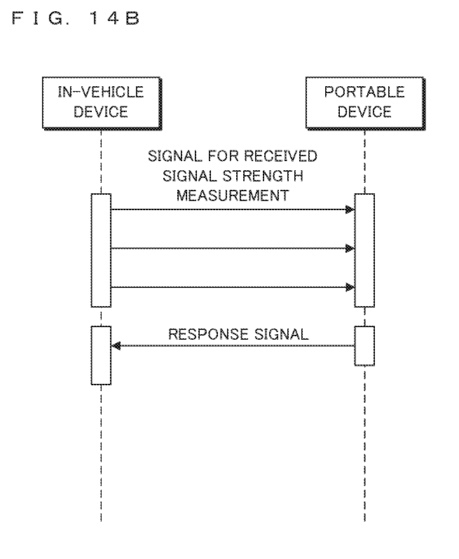

FIGS. 14A and 14B are sequence diagrams illustrating various signals transmitted and received between the in-vehicle device 1 and the portable device 2.

FIG. 14A illustrates a sequence of vehicle cabin inside-or-outside determination in a case that a signal for received signal strength measurement is transmitted from all transmitting antennas (3) including the transmitting antenna (3) having a low-level contribution to each vehicle cabin inside-or-outside determination, at the time that the vehicle door request switch (5a) is operated. Further, in FIG. 14A, at the time of performing vehicle cabin inside-or-outside determination, the vehicle cabin inside-or-outside determination of the portable device 2 is performed by using a plurality of areas.

FIG. 14B illustrates a sequence of vehicle cabin inside-or-outside determination in a case that a signal for received signal strength measurement is not transmitted from one transmitting antenna (3) having a low-level contribution to the vehicle cabin inside-or-outside determination but is transmitted from the other three transmitting antennas (3). Further, in FIG. 14B at the time of performing vehicle cabin inside-or-outside determination, the vehicle cabin inside-or-outside determination of the portable device 2 is performed by using one area selected in accordance with which vehicle door request switch (5a) has been operated.

Here, each of FIGS. 14A and 14B illustrates the sequence of processing that: the in-vehicle device 1 transmits a signal for received signal strength measurement to the portable device 2; then the portable device 2 having received the signal measures the received signal strength of each signal and then transmits to the in-vehicle device 1 a response signal containing the received signal strength obtained by the measurement; and then the in-vehicle device 1 performs vehicle cabin inside-or-outside determination. Each vertically elongated rectangular portion indicates the time in which the in-vehicle device 1 and the portable device 2 are executing the processing.

The processing time in which the in-vehicle device 1 transmits a signal for received signal strength measurement from the three transmitting antennas (3) having a high-level contribution to the vehicle cabin inside-or-outside determination and then the portable device 2 measures the received signal strength of each signal as illustrated in FIG. 14B is shorter than the processing time in which the signal is transmitted from all transmitting antennas (3) as illustrated in FIG. 14A. Further, the processing time of the vehicle cabin inside-or-outside determination performed by the in-vehicle device 1 having received the response signals is shorter in the case that the vehicle cabin inside-or-outside determination is performed by using the selected one area (FIG. 14B) than in the case that the vehicle cabin inside-or-outside determination is performed by using all areas (FIG. 14A).

As such, according to the present Embodiment 3, in the in-vehicle device 1, the time required for the vehicle cabin inside-or-outside determination is allowed to be reduced without causing degradation in the vehicle cabin inside-or-outside determination accuracy of the portable device 2.

(Modification 3)

Embodiment 3 has been described for an example that the in-vehicle device 1 performs the vehicle cabin inside-or-outside determination of the portable device 2. Instead, a configuration may be employed that the portable device 2 itself performs the vehicle cabin inside-or-outside determination. The configuration of the vehicle-use communication system according to Modification 3 is similar to the configuration of Embodiment 3 and hence the in-vehicle device 1 and the portable device 2 are provided. In the portable device 2, the storage part 24 stores: the first statistical values and the second statistical values that set forth the first to the third area 61, 62, and 63; the correspondence relation between the vehicle door request switch (5a) and the transmitting antenna (3) in the vehicle C; and a computer program of the present patent disclosure. In the vehicle-use communication system of Modification 3, similarly to Modification 1, the processing of step S106 described in FIG. 9 and the processing of step S107, i.e., step S321 to step S328 in FIG. 13, are suitably executed by the control part 21 of the portable device 2 so that the vehicle cabin inside-or-outside determination result is transmitted to the in-vehicle device 1.

According to Modification 3, similarly to Embodiment 3, a signal is not transmitted from an antenna having a low-level contribution to each vehicle cabin inside-or-outside determination. Thus, without causing degradation in the vehicle cabin inside-or-outside determination accuracy of the portable device 2, the time required for the vehicle cabin inside-or-outside determination is allowed to be reduced further. The time allowed to be reduced is similar to the above-described one. The other effects are similar to those of Embodiments 1 to 3.

### Embodiment 4

In a vehicle-use communication system according to Embodiment 4, the vehicle cabin inside-or-outside determination of the portable device 2 executed in accordance with which vehicle door request switch (5a) has been operated is performed by using a discriminant in place of the statistical values. In the vehicle-use communication system according to Embodiment 4, the contents of the information stored in the storage part 14 of the in-vehicle device 1 and the processing procedure of the ordinary determination performed by the control part 11 are different from those of Embodiments 1 to 3. Thus, the following description is given mainly for these differences. The other configurations and operation effects are similar to those of Embodiments 1 to 3. Thus, corresponding parts are designated by like numerals and then detailed description is not given.

The storage part 14 of the in-vehicle device 1 stores a discriminant for distinguishing whether the portable device 2 is located on the inner side or the outer side of the first area 61 on the basis of the received signal strengths of the signals transmitted from the plurality of transmitting antennas (3). Similarly to Embodiment 1, the received signal strengths are measured by the signal strength measurement part 23b of the portable device 2. The first area 61 is one area on which the determination of whether the portable device 2 is located on the inner side is to be performed by the control part 11, and contains a “common vehicle cabin inner space” on which determination of whether the portable device 2 is located in the vehicle cabin inside or the vehicle cabin outside is to be performed.

In other words, the storage part 14 stores a discriminant for distinguishing the received signal strengths measured in the outside of the vehicle cabin on the driver side from the received signal strengths measured in the other locations. For example, the discriminant is an approximation formula of a curve that joins together the received signal strengths where the Mahalanobis distance from the sample group characterizing the inner side of the first area 61 and the Mahalanobis distance from the sample group characterizing the outer side of the first area 61 become equal to each other. For example, the discriminant is expressed by the following formula (7).

Y=Aₙχ₁ⁿ+Aₙ₋₁χ₁ⁿ⁻¹+ . . . +A₁χ₁+B (7)

where
Aₙ, Aₙ₋₁, . . . A₁, B: constants setting forth the function of individual components of received signal strength vector where Mahalanobis distance from sample group of inner side of first area becomes equal to Mahalanobis distance from sample group of outer side of first area

Further, in the storage part 14, each discriminant for distinguishing the inside and the outside of each of the second to the third area 62 and 63 is expressed by the polynomial of the above-described formula (7). Here, each coefficient of the polynomial is a constant that sets forth the function of each component of the received signal strength vector where the Mahalanobis distance from the sample group of the inner side of each area and the Mahalanobis distance from the sample group of the outer side of each area become equal to each other. Thus, needless to say, each discriminant for distinguishing each area is expressed by a different function.

In the in-vehicle device 1 in the vehicle-use communication system described above, in the processing other than that describing below, a processing procedure similar to that described in FIG. 9, 11, 12, or 13 is executed. In place of the processing of selecting the statistical values at step S106 in FIG. 9, the control part 11 of the in-vehicle device 1 executes the processing of selecting the discriminant. At that time, similarly to Embodiment 1, the storage part 14 is constructed such as to store each discriminant for distinguishing the first to the third area 61, 62, and 63, in correspondence to an ID identifying each area. By virtue of this, the control part 11 is allowed to execute the determination.

After that, in the subroutine of vehicle cabin inside-or-outside determination, by using the received signal strengths of the received response signals and the selected discriminant, the control part 11 performs determination of whether the portable device 2 is located within the one area serving as the discrimination object of the discriminant. For example, in a case that the received signal strength vector is of two dimensions, a function value Y obtained such that one received signal strength contained in the response signal is substituted into χ¹ of the formula (7) given above is compared with another received signal strength contained in the response signal so that the determination is performed.

More specifically, in the subroutine of vehicle cabin inside-or-outside determination of Embodiment 1, the control part 11 does not perform the processing of step S123 and step S124 in FIG. 11 and instead performs the above-described determination employing the received signal strengths and the discriminant. Further, in the subroutine of vehicle cabin inside-or-outside determination of Embodiment 2, the control part 11 does not perform the processing of step S224 and step S225 in FIG. 12 and instead performs the above-described determination employing the received signal strengths selected at step S223 and the discriminant. Further, in the subroutine of vehicle cabin inside-or-outside determination of Embodiment 3, the control part 11 does not perform the processing of step S324 and step S325 and instead performs the above-described determination employing the received signal strengths and the discriminant.

As described above, according to the vehicle-use communication system and the in-vehicle device 1 of the present Embodiment 4, the vehicle cabin inside-or-outside determination of the portable device 2 is performed by using the discriminant selected in accordance with which vehicle door request switch (5a) has been operated. This discriminant is a polynomial adjusted such that each of the first to the third area 61, 62, and 63 may contain the common cabin inner space. This permits more accurate determination of whether the portable device 2 is located on the inner side or the outer side of the vehicle cabin inner space, than in Embodiments 1 to 3. Further, similarly to Embodiments 1 to 3, the number of processes required for generation of the discriminant is allowed to be suppressed.

(Modification 4)

Embodiment 4 has been described for an example that the in-vehicle device 1 performs the vehicle cabin inside-or-outside determination of the portable device 2. Instead, a configuration may be employed that the portable device 2 itself performs the vehicle cabin inside-or-outside determination. The configuration of the vehicle-use communication system according to Modification 4 is similar to the configuration of Embodiment 4 and hence the in-vehicle device 1 and the portable device 2 are provided. In the portable device 2 of Modification 4, the storage part 24 stores: a discriminant for distinguishing whether itself is located within each of the first to the third area 61, 62, and 63; and a computer program of the present patent disclosure. In the vehicle-use communication system of Modification 4, similarly to Modification 1, the processing of step S106 described in FIG. 9 and the processing of step S107 are suitably executed by the control part 21 of the portable device 2 so that the vehicle cabin inside-or-outside determination result is transmitted to the in-vehicle device 1.

According to Modification 4, the vehicle cabin inside-or-outside determination of the portable device 2 is performed by using the discriminant selected in accordance with which vehicle door request switch (5a) has been operated. Similarly to Embodiment 4, the discriminant is a polynomial adjusted such that each of the first to the third area 61, 62, and 63 may contain the common cabin inner space. This permits more accurate determination of whether the portable device 2 is located on the inner side or the outer side of the vehicle cabin inner space, than in Embodiments 1 to 3. The other effects are similar to those of Embodiments 1 to 4.

Here, statistical values, a discriminant different from the statistical values or the discriminant described in Embodiments 1 to 4 or Modifications 1 to 4, or a computer program may be stored in the storage part 14 and then may be used in the processing of vehicle cabin inside-or-outside determination. That is, a sorter sorting the inside and the outside of each area may be learned by using the sample group characterizing the inner side of each area 61 to 63 and the sample group characterizing the outer side which have been acquired in advance, and then the information expressing the learned sorter may be stored in the storage part 14. At that time, the sorter may be one performing linear sorting or, alternatively, may be one performing nonlinear sorting. Further, the learning of the sorter may be achieved by using various machine learning algorithms. Further, the in-vehicle device 1 may have a configuration that the storage part 14 stores each sample group itself acquired in advance and then, at each time that the vehicle cabin inside-or-outside determination of the portable device 2 is performed, the received signal strengths used in the determination are stored as a new sample into the storage part 14. At that time, in the in-vehicle device 1, when determination of whether the portable device 2 is located in the outside of the vehicle cabin or in the inside of the vehicle cabin is newly performed by using the subroutine of ordinary determination, may perform the determination by using semi-supervised learning.

The embodiments disclosed above are to be regarded as exemplary at all points and as not restrictive. The scope of the present invention is defined by the scope of the claims rather than the above-described meaning and is intended to include all changes within the scope of the claims and the scope or the meaning equivalent thereto.

The following description is disclosed in addition to the description given above.

(Additional Description 1)

A vehicle-use communication system comprising: an in-vehicle device, when any one of a plurality of operation parts provided in an outer face of a vehicle is operated, transmitting a signal from a plurality of antennas provided on the vehicle; and a portable device receiving the signal transmitted from the in-vehicle device, then measuring a received signal strength of the received signal, and then transmitting a response signal containing the measured received signal strength of the signal, wherein

the in-vehicle device includes:

a storage part storing information concerning each of a plurality of areas different from each other but containing a common vehicle cabin inner space;

an identification part identifying an operation part having been operated among the plurality of operation parts;

a selection part, in accordance with which operation part has been identified by the identification part, selecting information concerning one area from the information individually concerning the plurality of areas stored in the storage part;

an in-vehicle receiving part receiving the response signal transmitted from the portable device; and

a determination part, on the basis of the received signal strengths contained in the response signals received by the in-vehicle receiving part and on the basis of the information concerning the one area selected by the selection part, determining whether the portable device is located within the area.

(Additional Description 2)

The vehicle-use communication system described in additional description 1, wherein

each of the plurality of areas has a boundary that is along a part of an inner surface of the vehicle cabin, and wherein

the selection part selects the information concerning the area having a boundary that is along a part of the inner surface corresponding to the outer face where the operation part identified by the identification part is provided.

(Additional Description 3)

The vehicle-use communication system described in additional description 2, wherein

the storage part is constructed such as to store: a first statistical values based on a sample group of the received signal strengths measured at a plurality of locations along a part of the inner surface and on a sample group of the received signal strengths measured at a plurality of locations along an outer surface of the vehicle cabin; and a second statistical values based on a sample group of the received signal strengths measured at a plurality of locations along an outer surface of the part; as information concerning the area having a boundary that follows a part of the inner surface, and wherein

on the basis of the received signal strengths contained in the response signals received by the in-vehicle receiving part and on the basis of the first statistical values and the second statistical values concerning the one area selected by the selection part, the determination part determines whether the portable device is located within the area.

(Additional Description 4)

The vehicle-use communication system described in additional description 3, wherein

the first statistical values are based on a sample group of the received signal strengths measured at a plurality of locations along a part of the inner surface and based on a sample group of the received signal strengths measured at a plurality of locations along an inner surface and an outer surface of the other part that opposes the part of the inner surface.

(Additional Description 5)

The vehicle-use communication system described in additional description 3 or 4, wherein

the first statistical values and the second statistical values include a mean and an inverse variance-covariance matrix of the received signal strengths, wherein

the in-vehicle device includes a distance calculation part calculating: a statistical distance between the received signal strengths contained in the response signals received by the in-vehicle receiving part and the sample group concerning the first statistical values selected by the selection part; and a statistical distance between the received signal strengths contained in the response signals received by the in-vehicle receiving part and the sample group concerning the second statistical values selected by the selection part, and wherein

the determination part compares the statistical distances with each other so as to determine whether the portable device is located within the area corresponding to the first statistical values and the second statistical values selected by the selection part.

(Additional Description 6)

The vehicle-use communication system described in additional description 1 or 2, wherein

the storage part is constructed such as to store, as information concerning the area, a discriminant for distinguishing from each other the received signal strengths measured by the measurement part of the portable device located within the area and the received signal strengths measured by the measurement part of the portable device located on the outer side of the area, and wherein

on the basis of the received signal strengths contained in the response signals received by the in-vehicle receiving part and on the basis of the discriminant concerning the one area selected by the selection part, the determination part determines whether the portable device is located within the area.

(Additional Description 7)

The vehicle-use communication system described in any one of additional descriptions 1 to 6, wherein

the plurality of operation parts are provided at least in the right side face and the left side face of the vehicle, wherein

the storage part is constructed such as to store the information concerning the area having a boundary that follows the right inner surface of the vehicle cabin and the information concerning the area having a boundary that follows the left inner surface of the vehicle cabin, and wherein

the selection part,

in a case that the identification part has identified the operation part provided in the right side face, selects the information concerning the area having a boundary that follows the right inner surface and,

in a case that the identification part has identified the operation part provided in the left side face, selects the information concerning the area having a boundary that follows the left inner surface.

(Additional Description 8)

The vehicle-use communication system described in any one of additional descriptions 1 to 7, wherein

at least one of the plurality of operation parts is provided in the rear face of the vehicle, wherein

the storage part is constructed such as to store the information concerning the area having a boundary that follows the inner face of the rear side of the vehicle cabin, and wherein

in a case that the identification part has identified the operation part provided in the rear face, the selection part selects the information concerning the area having a boundary that follows the inner face of the rear side of the vehicle cabin.

(Additional Description 9)

The vehicle-use communication system described in any one of additional descriptions 1 to 8, wherein

the determination part is constructed such as to, on the basis of a part of the received signal strengths contained in the response signals received by the in-vehicle receiving part and on the basis of the information concerning the area selected by the selection part, determines whether the portable device is located within the area, the received signal strengths employed in the determination being different for each of the information concerning the area selected by the selection part.

(Additional Description 10)

The vehicle-use communication system described in any one of additional descriptions 1 to 8, wherein

the storage part is constructed such as to store one or a plurality of antennas in correspondence to each of the operation parts, and wherein

the in-vehicle device includes a transmission control part transmitting a signal through the one or the plurality of antennas stored in the storage part in correspondence to the operation part identified by the identification part.

According to additional description 3, in the in-vehicle device, the first statistical values and the second statistical values are stored as the information concerning the area in the storage part. Then, whether the portable device is located within the area is determined by using the first statistical values and the second statistical values.

The first statistical values are values calculated on the basis of the sample group of the received signal strengths measured at a plurality of locations along a part of the inner surface and on the basis of the sample group of the received signal strengths measured at a plurality of locations along the vehicle cabin outer side Among the sample groups used for calculation of the first statistical values, the sample group of the received signal strengths measured at a plurality of locations along the vehicle cabin outer side is used for ensuring that every one of the areas contains the common vehicle cabin inner space. Further, among the sample groups used for calculation of the first statistical values, the sample group of the received signal strengths measured at a plurality of locations along the part of the inner surface is used for setting forth a boundary corresponding to the part of the inner surface such that the vehicle cabin inside-or-outside determination in the part of the inner surface may be allowed to be accurately performed.

The second statistical values are values calculated on the basis of the sample group of the received signal strengths measured at a plurality of locations along the vehicle cabin outer side of the part of the inner surface. The sample group used for calculation of the second statistical values is used for setting forth a boundary of an area corresponding to the part such that the vehicle cabin inside-or-outside determination in the part of the inner surface may be allowed to be accurately performed.

Since the sample groups described above are utilized as the sample groups for calculating the first statistical values and the second statistical values, the number of processes required for generation of the statistical values used for the inside-or-outside determination of the portable device in the areas is effectively suppressed in comparison with a case that a huge sample group generated at random is employed.

According to additional description 4, whether the portable device is located within the area is determined by using the first statistical values and the second statistical values.

The first statistical values are values calculated on the basis of the sample group of the received signal strengths measured at a plurality of locations along the part of the inner surface and on the basis of the sample group of the received signal strengths measured at a plurality of locations along the inner surface and the outer surface of the other part that opposes the part of the inner surface. Among the sample groups used for calculation of the first statistical values, the sample group of the received signal strengths measured at a plurality of locations along the vehicle cabin inner side and the vehicle cabin outer side of the other part is used for ensuring that every one of the areas contains the other part. Further, among the sample groups used for calculation of the first statistical values, the sample group of the received signal strengths measured at a plurality of locations along the part of the inner surface is used for setting forth a boundary corresponding to the part of the inner surface such that the vehicle cabin inside-or-outside determination in the part of the inner surface may be allowed to be accurately performed.

The second statistical values are values calculated on the basis of the sample group of the received signal strengths measured at a plurality of locations along the outer surface of the part. The sample group used for calculation of the second statistical values is used for setting forth a boundary of an area corresponding to the part such that the vehicle cabin inside-or-outside determination in the part of the inner surface may be allowed to be accurately performed.

Since the sample groups described above are utilized as the sample groups for calculating the first statistical values and the second statistical values, the number of processes required for generation of the statistical values used for the inside-or-outside determination of the portable device in the areas is effectively suppressed in comparison with a case that a huge sample group generated at random is employed.

According to additional description 5, by using the first statistical values, the in-vehicle device calculates a statistical distance between the sample group characterizing the inner side of the area and the received signal strengths measured by the portable device. Further, by using the second statistical values, the in-vehicle device calculates a statistical distance between the sample group characterizing the outer side of the area and the received signal strengths measured by the portable device. The determination part of the in-vehicle device compares the calculated statistical distances with each other so as to determine whether the portable device is located on the inner side or the outer side of the area corresponding to the first statistical values and the second statistical values selected by the selection part. If the statistical distance from the sample group characterizing the inner side of the area is shorter than the statistical distance from the sample group characterizing the outer side of the area, it is determined that the portable device is located within the area. In contrast, if the statistical distance from the sample group characterizing the outer side of the area is shorter than the statistical distance from the sample group characterizing the inner side of the area, it is determined that the portable device is located on the outer side of the area.

According to additional description 6, in the in-vehicle device, the storage part stores the discriminant as the information concerning the area. Then, whether the portable device is located on the inner side or the outer side of the area is determined by using the discriminant. Each of the plurality of areas is insufficient for determining whether the portable device is located on the inner side or the outer side of the vehicle cabin inner space. However, since the accuracy of the boundary of the area is low, the number of processes required for generation of the discriminant setting forth the area is suppressed. For example, the discriminant is allowed to be generated by employing an approximation formula constructed from a low-order polynomial setting forth the boundary of the area.

More specifically, in the discriminant in the present patent disclosure, a plurality of points where the statistical distance from the vehicle-cabin inside sample group and the statistical distance from the vehicle-cabin outside sample group become equal to each other are acquired and adopted as the whole set. Here, the vehicle-cabin inside sample group contains the sample group of the received signal strengths measured at a plurality of locations along a part of the inner surface of the vehicle cabin. Further, the vehicle-cabin outside sample group contains the sample group of the received signal strengths measured at a plurality of locations along the outer surface of the part.

Then, a subset contributing to the inside-or-outside determination of the portable device is extracted from the whole set and then an approximated curve expressing the subset is acquired by using the extracted subset by the least square method.

For example, in a case that two-dimensional samples each containing the received signal strengths of signals transmitted from two antennas are employed, the points where the statistical distance from the vehicle-cabin inside sample group and the statistical distance from the vehicle-cabin outside sample group become equal to each other are allowed to be plotted on a two-dimensional plane. Then, the shape thereof becomes a hyperbola, a parabola, or an ellipse. A combination of antennas in which the shape described here becomes an ellipse is not employed. Then, for example, in a case that the shape is a hyperbola, a subset constructed from a plurality of points located on a curve contributing to the inside-or-outside determination of the portable device is extracted. Since the shape of the curve expressing the subset becomes a parabola, accurate approximation is allowed to be achieved by using a low-order polynomial by the least square method.

In the present discriminant, it is sufficient that the received signal strengths are measured in the inside and the outside in the vicinity of the boundary of the area. Thus, the number of processes required for generation of parameters used for determining whether the portable device is located on the inner side or the outer side of the boundary in each area is suppressed.

Here, the particular example of the discriminant described here is exemplary and hence the generation method and the dimension of the discriminant employed in the present patent disclosure are not limited to particular ones.

According to additional description 7, in the in-vehicle device, in a case that the operation part provided in the right side face of the vehicle has been operated, the information concerning the area having a boundary that follows the right inner surface of the vehicle cabin is selected by the selection part and then vehicle cabin inside-or-outside determination is performed on the area. Further, in the in-vehicle device, in a case that the operation part provided in the left side face of the vehicle has been operated, the information concerning the area having a boundary that follows the left inner surface of the vehicle cabin is selected by the selection part and then vehicle cabin inside-or-outside determination is performed on the area. Thus, the vehicle cabin inside-or-outside determination of the portable device is allowed to be accurately performed in the right inner surface and the left inner surface of the vehicle cabin. Here, the boundary of each area is not required to completely match the right side face and the left side face of the vehicle cabin.

According to additional description 8, in the in-vehicle device, in a case that the operation part provided in the rear face has been operated, the information concerning the area having a boundary that follows the rear inner face of the vehicle cabin is selected by the selection part and then vehicle cabin inside-or-outside determination is performed on the area. Thus, the vehicle cabin inside-or-outside determination of the portable device is allowed to be accurately performed in the rear inner face of the vehicle cabin in the rear face. Accordingly, the vehicle cabin inside-or-outside determination of the portable device is allowed to be accurately performed in the rear inner face of the vehicle cabin. Here, the boundary line of the area is not required to completely match the rear inner face of the vehicle cabin.

1.-7. (canceled)

8. A vehicle-use communication system comprising: an in-vehicle device, when any one of a plurality of operation parts provided in an outer face of a vehicle is operated, transmitting a signal from a plurality of antennas provided on the vehicle; and a portable device receiving the signal transmitted from the in-vehicle device, measuring a received signal strength of the received signal, and transmitting a response signal containing the measured received signal strength of the signal, wherein
the in-vehicle device includes:
a storage part storing information concerning each of a plurality of areas different from each other but containing a common vehicle cabin inner space;
an identification part identifying an operation part having been operated among the plurality of operation parts;
a selection part, in accordance with which operation part has been identified by the identification part, selecting information concerning one area from the information individually concerning the plurality of areas stored in the storage part;
an in-vehicle receiving part receiving the response signal transmitted from the portable device; and
a determination part, on the basis of the received signal strengths contained in the response signals received by the in-vehicle receiving part and on the basis of the information concerning the one area selected by the selection part, determining whether the portable device is located within the area, wherein
the information concerning the area contains a statistical value that is calculated on the basis of sampled values obtained by measuring in advance the received signal strengths of the signals transmitted from the plurality of antennas and that sets forth the area, and wherein
the determination part calculates a statistical distance between the received signal strengths contained in the response signals received by the in-vehicle receiving part and the statistical value concerning the one area selected by the selection part and thereby determines whether the portable device is located within the area.

9. The vehicle-use communication system according to claim 8, wherein each of the plurality of areas has a boundary that is along a part of an inner surface of the vehicle cabin, and wherein the selection part selects the information concerning the area having a boundary that is along a part of the inner surface corresponding to the outer face where the operation part identified by the identification part is provided.

10. The vehicle-use communication system according to claim 8, wherein the determination part is constructed such as to, on the basis of a part of the received signal strengths contained in the response signals received by the in-vehicle receiving part and on the basis of the information concerning the area selected by the selection part, determines whether the portable device is located within the area, the received signal strengths employed in the determination being different for each of the information concerning the area selected by the selection part.

11. The vehicle-use communication system according to claim 8, wherein the storage part is constructed such as to store one or a plurality of antennas in correspondence to each of the operation parts, and wherein the in-vehicle device includes a transmission control part transmitting a signal through the one or the plurality of antennas stored in the storage part in correspondence to the operation part identified by the identification part.

12. An in-vehicle device, when any one of a plurality of operation parts provided in an outer face of a vehicle is operated, transmitting a signal from a plurality of antennas arranged in the vehicle and receiving a response signal transmitted from an external equipment in accordance with the signal, comprising:
a storage part storing information concerning each of a plurality of areas different from each other but containing a common vehicle cabin inner space;
an identification part identifying an operation part having been operated among the plurality of operation parts;
a selection part, in accordance with which operation part has been identified by the identification part, selecting information concerning one area from the information individually concerning the plurality of areas stored in the storage part;
an in-vehicle receiving part receiving the response signals containing received signal strengths of the signals individually transmitted from the plurality of antennas measured at the external equipment; and
a determination part, on the basis of the received signal strengths contained in the response signals received by the in-vehicle receiving part and on the basis of the information concerning the one area selected by the selection part, determining whether the external equipment is located within the area, wherein
the information concerning the area contains a statistical value that is calculated on the basis of sampled values obtained by measuring in advance the received signal strengths of the signals transmitted from the plurality of antennas and that sets forth the area, and wherein
the determination part calculates a statistical distance between the received signal strengths contained in the response signals received by the in-vehicle receiving part and the statistical value concerning the one area selected by the selection part and thereby determines whether the external equipment is located within the area.

13. A portable device receiving a plurality of signals transmitted from a vehicle provided with a plurality of operation parts formed in an outer face when any one of the plurality of operation parts is operated, and transmitting response signals in accordance with the received signals, comprising:
a storage part storing information concerning each of a plurality of areas different from each other but containing a common vehicle cabin inner space;
an identification part, on the basis of the received signals, identifying an operation part having been operated among the plurality of operation parts;
a selection part, in accordance with which operation part has been identified by the identification part, selecting information concerning one area from the information individually concerning the plurality of areas stored in the storage part;
a measurement part measuring received signal strengths of the plurality of signals; and
a determination part, on the basis of the received signal strengths measured by the measurement part and on the basis of the information concerning the one area selected by the selection part, determining whether itself is located within the area, wherein
the information concerning the area contains a statistical value that is calculated on the basis of sampled values obtained by measuring in advance the received signal strengths of the signals transmitted from the plurality of antennas and that sets forth the area, and wherein
the determination part calculates a statistical distance between the received signal strengths measured by the measurement part and the statistical value concerning the one area selected by the selection part and thereby determines whether itself is located within the area.

14. A non-transitory computer-readable recording medium storing a computer program causing a computer to, on the basis of received signal strengths of signals which have been transmitted from a plurality of antennas arranged on a vehicle at a time that any one of a plurality of operation parts provided in an outer face of the vehicle is operated and which have been received by a portable device, determine whether the portable device is located within the vehicle cabin, wherein
the computer is caused to serve as:
an identification part identifying an operation part having been operated among the plurality of operation parts;
a selection part, in accordance with which operation part has been identified, selecting one area from a plurality of areas different from each other but containing a common vehicle cabin inner space; and
a determination part calculating a statistical distance between the received signal strengths and a statistical value that is calculated on the basis of sampled values obtained by measuring in advance the received signal strengths of the signals transmitted from the plurality of antennas and that sets forth the one area, and thereby determining whether the portable device located within the selected one area.
